(19) United States
(12) Patent Application Publication
(10) Pub. No.: US 2025/0164946 A1
(43) Pub. Date: May 22, 2025

(54) COMPUTER IMPLEMENTED METHOD AND SYSTEM FOR DISPATCHING MACHINES VIA PRODUCTION CIRCUITS

(71) Applicant: Caterpillar Inc., Peoria, IL (US)

(72) Inventors: Russell A. Brockhurst, Carindale (AU); Kenneth Patrick Robinson, Brisbane (AU); Jan Sobus, Burpengary East (AU)

(73) Assignee: Caterpillar Inc., Peoria, IL (US)

(21) Appl. No.: 18/512,981

(22) Filed: Nov. 17, 2023

(51) Int. Cl. G05B 15/02

(52) U.S. Cl. CPC G05B 15/02

(57) ABSTRACT

A machine at a worksite may be assigned to one or more production circuits that each include a sequence of activities. Each activity in a production circuit may associated with corresponding entry criteria indicating conditions that, if satisfied by the machine, permit the machine to initiate performance of that activity. The machine may perform activities of a production circuit if the machine satisfies the corresponding entry criteria. If the machine does not satisfy entry criteria of an activity in an assigned production circuit, the machine may switch to performing activities of a different production circuit, such as a lower-priority production circuit that has also been assigned to the machine, that includes an activity with entry criteria that the machine does satisfy.

### TECHNICAL FIELD

The present disclosure relates to dispatching machines at a worksite and, more particularly, to dispatching machines to perform activities associated with production circuits.

### BACKGROUND

A machine, such as a haul truck, may perform various activities at a worksite. As an example, a haul truck may be loaded with material at a first location at the worksite, and transport the material to a second location at the worksite. As another example, a haul truck may travel to a weigh station at the worksite, such that the haul truck may be weighted at the weigh station.

Various systems have been developed in the past to dispatch machines to perform activities at worksites. For example, U.S. Publication 2019/0318629 to Ranjan (hereinafter “Ranjan”) describes a logistics system that may use real-time information to adjust operations on a worksite, for instance by adjusting which tasks machines are assigned to perform in response to changes in demand and/or to reduce non-productive time at the worksite. Accordingly, the logistics system described by Ranjan is focused on dispatching machines to perform specific operations in real-time, and may have limited abilities to assign machines to perform sequences of operations that may be performed without real-time management of the machines.

Examples of the present disclosure are directed to overcoming the deficiencies noted above.

### SUMMARY

According to a first aspect of the present disclosure, a computer-implemented method includes identifying, by a computing system including a processor, a production circuit assigned to a machine at a worksite. The production circuit includes a sequence of activities associated with operations at the worksite. Individual activities, of the sequence of activities, are associated with corresponding entry criteria defining conditions for performing the individual activities. The computer-implemented method also includes determining, by the computing system, and based on sensor data indicative of a state of the machine, that the machine satisfies the entry criteria associated with an activity of the production circuit. The computer-implemented method additionally includes causing, by the computing system, and based on determining that the machine satisfies the entry criteria associated with the activity, the machine to perform the activity.

According to a second aspect of the present disclosure, a machine includes one or more sensors and a computing system. The one or more sensors are configured to determine sensor data indicative of a state of the machine. The computing system includes a processor and memory having stored thereon computer-executable instructions. The computer-executable instructions, when executed by the processor, cause the processor to identify a production circuit assigned to the machine. The production circuit includes a sequence of activities associated with operations at a worksite. Individual activities, of the sequence of activities, are associated with corresponding entry criteria defining conditions for performing the individual activities. The computer-executable instructions also cause the processor to determine, based on the sensor data, that the machine satisfies the entry criteria associated with an activity of the production circuit. The computer-executable instructions additionally cause the processor to, based on determining that the machine satisfies the entry criteria associated with the activity, cause the machine to perform the activity.

According to a third aspect of the present disclosure, a computing system includes a processor and a memory having stored thereon computer-executable instructions. The computer-executable instructions, when executed by the processor, cause the processor to identify a production circuit assigned to a machine at a worksite. The production circuit includes a sequence of activities associated with operations at the worksite. Individual activities, of the sequence of activities, are associated with corresponding entry criteria defining conditions for performing the individual activities. The computer-executable instructions also cause the processor to determine, based on sensor data indicative of a state of the machine, that the machine satisfies the entry criteria associated with an activity of the production circuit. The computer-executable instructions additionally cause the processor to, based on determining that the machine satisfies the entry criteria associated with the activity, cause the machine to perform the activity.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is an exemplary diagrammatic illustration of a worksite at which a machine is assigned to at least one production circuit.

FIG. 2 shows an exemplary illustration of a ranked set of production circuits that may be assigned to a machine.

FIG. 3 is a flowchart illustrating an exemplary process for generating production circuits and assigning production circuits to machines.

FIG. 4 is a flowchart illustrating an exemplary process for switching between production circuits assigned to a machine.

FIG. 5 is a schematic illustration depicting an exemplary architecture of a computing system that executes one or more elements described in the present disclosure.

### DETAILED DESCRIPTION

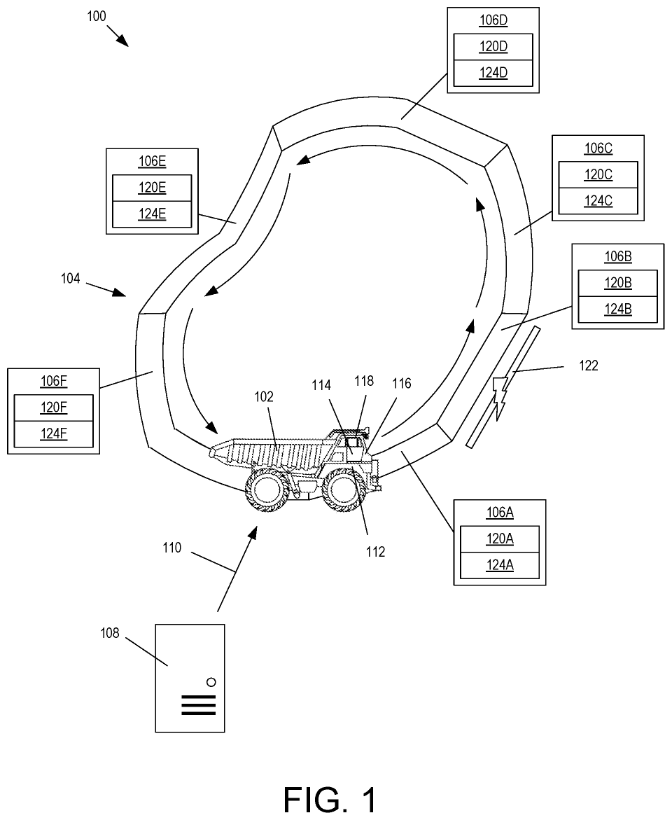

FIG. 1 is an exemplary diagrammatic illustration of a worksite 100 at which a machine 102 is assigned to at least one production circuit 104. A production circuit 104 includes a sequence of activities 106 that the machine 102 may perform at the worksite 100. The activities 106 of the production circuit 104 may be associated with various types of work operations at the worksite 100, as described further below. The machine 102 may accordingly perform individual activities 106 of an assigned production circuit 104 in a sequence associated with the production circuit 104.

A production circuit 104 may include any number of activities 106. For instance, FIG. 1 shows an example in which a production circuit 104 includes activity 106A, activity 106B, activity 106C, activity 106D, activity 106E, and activity 106F (collectively referred to as activities 106). However, a production circuit 104 may include fewer activities 106, or more activities 106, than shown in FIG. 1. For instance, in some examples, different production circuits 104 may include different numbers of activities 106.

A dispatch controller 108 associated with the worksite 100 may assign the machine 102 to one or more production circuits 104. The dispatch controller 108 may have predefined information associated with production circuits 104, such as information that defines the activities 106 and sequence of activities 106 associated with each of the production circuits 104. The dispatch controller 108 may assign individual machines 102 to one or more of the production circuits 104.

For example, the dispatch controller 108 may transmit production circuit assignment data 110 to the machine 102 as described further below. The production circuit assignment data 110 may identify one or more production circuits 104 to which the machine 102 is assigned. The production circuit assignment data 110 may also indicate information associated with individual activities 106 of corresponding production circuits 104.

The dispatch controller 108 may assign one or more machines 102 at the worksite 100 to the same production circuit 104 and/or to different production circuits 104. Although an example of one production circuit 104 is shown in FIG. 1, the dispatch controller 108 may assign a particular machine 102 to multiple different production circuits 104. Additionally, the dispatch controller 108 may assign different machines 102 at the worksite 100 to the same production circuit 104 and/or to different production circuits 104.

Different production circuits 104 may include different types of activities 106 and/or different sequences of activities 106. In some examples, production circuit assignment data 110 sent by the dispatch controller 108 to a particular machine 102 may include a ranked list of different production circuits 104 assigned to the particular machine 102, such that the particular machine 102 may perform activities 106 associated with different production circuits 104 at different times and/or in different situations as discussed further below.

The dispatch controller 108 may be a computer-implemented system that executes via one or more servers, computers, or other off-board computing devices or computing systems that are separate from the machine 102. Computing elements that execute the dispatch controller 108 may be present on-site at the worksite 100, or may be located at a back office or other location that is remote from the worksite 100.

The worksite 100 may be a mine site, a quarry, a construction site, or any other type of worksite or work environment. The machine 102 may, in some examples, be a commercial or work machine, such as a mining machine, earth-moving machine, backhoe, scraper, dozer, loader (e.g., large wheel loader, track-type loader, etc.), shovel, truck (e.g., mining truck, haul truck, on-highway truck, off-highway truck, articulated truck, etc.), a crane, a pipe layer, a water truck or other machine that dispenses fluid or other material, farming equipment, or any other type of machine or vehicle. In some examples, multiple machines 102 of the same type, and/or different types, may operate at the worksite 100.

In some examples, the machine 102 may be at least partially powered by a battery 112. For example, the machine 102 may be a battery electric machine (BEM), a hybrid machine, a fuel cell and battery hybrid machine, or another machine that is at least partially powered by a battery 112. The battery 112 may be a lithium-ion (Li-ion) battery, lithium-ion polymer battery, nickel-metal hydride (NiMH) battery, lead-acid battery, nickel cadmium (Ni—Cd) battery, zinc-air battery, sodium-nickel chloride battery, or other types of battery that may at least partially power the machine 102.

In other examples, the machine 102 may be a fuel-powered machine that operates based on power provided by an internal combustion engines and/or other elements that consume fuel. In some of these examples, a fuel-powered machine 102 may also have a battery 112 that powers at least some operations of the machine 102, and/or may have elements powered by electricity. As an example, the machine 102 may be a fuel-powered diesel electric machine that uses one or more electric drives for propulsion. In other examples, the machine 102 may be another type of electric drive machine that has one or more electric drives powered by one or more external power sources. For instance, an electric drive of such an electric drive machine may be powered via a connection with a trolley system or other external power source, as described further below.

The machine 102 may be a staffed manually operated machine, a fully autonomous machine, or a semi-autonomous machine. The machine 102 may have an electronic control module (ECM) 114 and/or other on-board computing devices that may cause the machine 102 to perform autonomous or semi-autonomous operations. The ECM 114 may also perform on-board processing operations associated with one or more production circuits 104 as described herein.

For instance, in some examples the ECM 114 may determine whether the machine 102 may perform activities 106 associated with a production circuit 104, and/or determine which assigned production circuit 104 to perform as described further below. If the machine 102 is an autonomous or semi-autonomous machine, the ECM 114 may cause the machine 102 to perform activities 106 associated with a production circuit 104 autonomously or semi-autonomously. If the machine 102 is a staffed machine or a semi-autonomous machine that is at least partially controlled by a human operator, the ECM 114 may present instructions via a dashboard display or other user interface to prompt the human operator to cause the machine 102 to perform activities 106 associated with a production circuit 104.

The machine 102 may have one or more sensors 116 that measure, collect, or otherwise determine one or more types of sensor data associated with the machine 102 and/or operations of the machine 102. For example, the sensors 116 may include cameras, LIDAR sensors, RADAR sensors, other optical sensors or perception systems, Global Positioning System (GPS) sensors, other location and/or positioning sensors, incline and decline travel sensors, speed sensors, work tool position sensors, temperature sensors, tire pressure sensors, battery sensors, fuel sensors, payload weight sensors, other payload monitoring sensors, material type and/or grade sensors, material moisture level sensors, and/or other types of sensors.

As an example, one or more sensors 116 may measure or determine attributes of the battery 112 of the machine 102, such as a health of the battery 112, a charge state of the battery 112, and/or other types of information associated with the battery 112. For instance, one or more sensors 116 may determine a charge state of the battery 112 based on, and/or by determining, attributes such as a state of charge (SoC) associated with a percentage of a total energy capacity of the battery 112, a stored energy level based on Amp Hours (Ah) or Watt Hours (Wh), a remaining capacity based on Ah or Wh, and/or other types of attributes indicative of the charge state of the battery 112.

Such sensors 116 of the machine 102 may be operably coupled to the ECM 114 and/or other on-board computing systems of the machine 102, and may provide corresponding sensor data to the ECM 114 and/or other on-board computing systems of the machine 102. Sensor data provided by sensors 116 may, in some examples, enable the ECM 114 of the machine 102 to cause the machine 102 to drive and/or operate autonomously or semi-autonomously. In some examples, the sensor data may also, or alternately, be sent by the ECM 114 or other elements of the machine 102 to the dispatch controller 108 and/or other off-board computing systems as described further below. As described further below, sensor data and/or other types of data associated with a state of the machine 102 may also, or alternately, be used by the ECM 114, the dispatch controller 108, and/or other elements to determine whether the machine 102 is eligible to perform an activity 106 of a production circuit 104.

The machine 102 may have wireless communication interfaces 118 that are operably coupled to the ECM 114 and/or other on-board computing systems of the machines 102. The wireless communication interfaces 118 may be, or include, cellular interfaces, Wi-Fi® interfaces, Bluetooth® interfaces, machine-to-machine data interfaces, peer-to-peer data interfaces, and/or other types of wireless communication interfaces. For example, the wireless communication interfaces 118 may include one or more modems, receivers, transmitters, antennas, and/or other hardware or software elements configured to send and/or receive data. The dispatch controller 108 may have similar wireless communication interfaces, and/or wired communication interfaces, such that the dispatch controller 108 may exchange data with the ECM 114 of the machine 102.

The wireless communication interfaces 118 may allow the ECM 114 and/or other on-board computing systems of the machine 102 to exchange data with the dispatch controller 108. For example, the ECM 114 of the machine 102 may receive the production circuit assignment data 110 from the dispatch controller 108 via the wireless communication interfaces 118. In some examples, the ECM 114 of the machine 102 may also send sensor data and/or other types of data to the dispatch controller 108 via the wireless communication interfaces 118. For instance, the ECM 114 of the machine 102 may send machine telemetry data, location data, material tracking data, activity progress data, battery data, fuel level data, and/or other sensor data or other types of data to the dispatch controller 108.

In some examples, the wireless communication interfaces 118 may also allow the ECM 114 of the machine 102 to receive sensor data and/or other types of information from other machines 102 and/or other elements at the worksite 100. As an example, if the machine 102 is a haul truck and a loading machine loads material onto the haul truck, the loading machine may have sensor data or other data indicating how much material was loaded onto the haul truck, what type of material was loaded onto the haul truck, and/or other attributes of the material loaded onto the haul truck. The loading machine may use a peer-to-peer data connection, via the wireless communication interfaces 118, to transmit that information to the ECM 114 of the machine 102. Accordingly, the ECM 114 of the machine 102 may receive material tracking data and/or other types of sensor data associated with operations of the machine 102 from other elements at the worksite 100, instead of or in addition to sensors 116 of the machine 102. The ECM 114 of the machine 102 may accordingly process the received sensor data locally, and/or transmit the received sensor data to the dispatch controller 108 to be processed remotely, as described herein. In some examples, a loading machine or other element at the worksite 100 may also, or alternately, transmit corresponding sensor data to the dispatch controller 108, instead of or in addition to transmitting the sensor data to the machine 102 via peer-to-peer communications.

In some examples, the wireless communication interfaces 118 and/or other communication interfaces of the machine 102, the dispatch controller 108, and/or other elements may be configured to exchange data via connections with one or more network hotspots or other network infrastructure that may be installed at, or be otherwise available at, the worksite 100. For instance, if the worksite 100 is a mine site, network hotspots may be installed at the mine site such that the machine 102 and the dispatch controller 108 may communicate via the network hotspots. However, in some examples or situations as described herein, after the machine 102 receives production circuit assignment data 110 associated with one or more assigned production circuits 104 via the wireless communication interfaces 118, the machine 102 may perform activities 106 of the one or more assigned production circuit 104 even if network connectivity becomes unavailable or unreliable and the machine 102 does not have a persistent data connection with the dispatch controller 108.

As discussed above, a production circuit 104 may be a sequence of activities 106 that an assigned machine 102 may perform at the worksite 100. The activities 106 associated with a production circuit 104 may include one or more types of activities 106. The activities 106 may be associated with productive work operations at the worksite 100.

Although a production circuit 104 may be a sequence of activities 106, a machine 102 may begin performance of the production circuit 104 by performing any of the activities 106 of the production circuit 104. For instance, the production circuit 104 may not have a particular activity 106 that is defined as a starting activity 106 of the sequence, such that the machine 102 may begin performance of the production circuit 104 by performing any of the activities 106 of the production circuit 104. After performing one of the activities 106 of the production circuit 104, the machine 102 may continue performing subsequent activities 106 in the sequence of activities 106 associated with the production circuit 104, may repeat the sequence of activities 106 associated with the production circuit 104 one or more times, or may switch to a different production circuit 104 as described herein.

In some examples, activities 106 associated with a production circuit 104 may be associated with movement of material around the worksite 100. For example, if the machine 102 is a haul truck configured to transport material between locations at the worksite 100, activities 106 of a production circuit 104 may include a loading activity in which the machine 102 is loaded with material at a loading site, a loaded travel activity in which the machine 102 travels while loaded with material to a dumping site, a dumping activity in which the machine 102 dumps the material at the dumping site, and an unloaded travel activity in which the machine 102 travels back to the loading site or travels to a different loading site.

However, although a production circuit 104 may include activities 106 associated with loading and/or dumping of material as described above, a production circuit 104 may also include other types of activities 106 instead of, or in addition to, activities 106 associated with loading and/or dumping of material. For example, activities 106 may be associated with the machine 102 traveling to a lime silo, the machine 102 traveling to a weigh station to be weighed, the machine 102 traveling to a fueling station or to a battery charging station to be refueled and/or recharged, the machine 102 traveling under a camera so that images of material carried by the machine 102 may be captured, the machine 102 dispensing water or other fluid along a path, and/or any other types of activities 106 that may be performed at the worksite 100.

Some production circuits 104 may be relatively simple. As an example, a relatively simple production circuit 104 may involve a haul truck being loaded with material at a loading area, traveling while loaded with the material to a dump site, dumping the material at the dump site, and then returning to the loading area to be loaded with more material.

However, other production circuits 104 may be more complex, and involve more activities 106, and/or more types of activities 106, than a relatively simple production circuit 104. As an example, a complex production circuit 104 may involve a haul truck being loaded with a first type of material at a first loading area, traveling under a camera mounted on a gantry so that images of the first type of material carried by the haul truck may be captured, traveling to a weigh station so that that the combined weight of the haul truck and the first type of material may be measured, traveling to a first dump site, dumping the first type of material at the first dump site, traveling from the first dump site to a second loading area, being loaded with a second type of material at the second loading area, traveling to a second dump site, dumping the second type of material at the second dump site, and then returning back to the first loading area.

A production circuit 104 may also be associated with another type of machine different than a haul truck. As an example, a production circuit 104 may be associated with a water truck that is configured to dispense water to control dust at a mine site or other type of worksite 100. In this example, the activities 106 of the production circuit 104 may include the water truck being filled with water at a first location, traveling along a route to a first area while not dispensing water, making a designated sequence of passes through the first area while dispensing water, traveling to a second area while dispensing water between the first area and the second area, making a designated sequence of passes through the second area while dispensing water, and then returning to the first location or to a second location where the water truck may be refilled with water.

In examples in which the machine 102 is a BEM or is otherwise at least partially powered by a battery 112, some activities 106 of a production circuit 104 may be associated with charging and/or discharging the battery 112 of the machine 102. In examples in which the machine 102 is a fuel-powered machine, the machine 102 may consume fuel during performance of activities 106 of a production circuit 104.

Individual activities 106 of a production circuit 104 may accordingly be associated with corresponding energy use profiles 120. Energy use profiles 120 associated with activities 106 indicate how much energy is expected to be expended and/or gained by the machine 102 while performing the activities 106. For example, if the machine 102 is a BEM or is otherwise at least partially powered by a battery 112, energy use profiles 120 corresponding to individual activities 106 of a production circuit 104 may indicate predictions or estimates of how much the battery 112 will be charged and/or discharged during performance of the activities 106. If the machine 102 is a fuel-powered machine, the energy use profiles 120 corresponding to individual activities 106 of a production circuit 104 may indicate predictions or estimates of how much fuel the machine 102 will consume during performance of the activities 106.

Some activities 106 may be dedicated to charging or discharging the battery 112 of a machine 102. For instance, an activity 106 of a production circuit 104 may be a dedicated charging activity in which the machine 102 is stationary and waits at a charge station located at the worksite 100 while the battery 112 is charged via the charge station. Accordingly, the energy use profile 120 associated with the dedicated charging activity may indicate how much energy will be received by the machine 102, and/or used to charge the battery 112, while connected to the charge station.

However, other activities 106 may involve charging and/or discharging the battery 112 while the machine 102 is traveling and/or performing other operations. For instance, the battery 112 may be discharged when the machine 102 uses energy from the battery 112 to perform operations during some activities 106. The battery 112 also may be charged because of, and/or during, performance of other activities 106 by the machine 102.

As an example, the machine 102 may have a regenerative brake system that is configured to capture kinetic energy and/or potential energy during braking and/or deceleration of the machine 102, and to store the captured energy in the battery 112. Accordingly, an activity 106 of a production circuit 104 that involves the machine 102 traveling downhill while controlling a travel speed via the regenerative brake system, or otherwise involves the machine 102 performing braking operations via the regenerative brake system, may cause the regenerative brake system to charge the battery 112. The energy use profile 120 associated with that activity 106 may indicate how much energy is expected to be captured by the regenerative brake system, and used to charge the battery 112, during performance of the activity 106 by the machine 102.

As another example, an activity 106 of a production circuit 104 may involve the machine 102 connecting to a trolley system 122. The trolley system 122 may transfer energy to the machine 102 while the machine 102 travels along a length of the trolley system 122, such that the machine 102 may receive energy and/or charge the battery 112 while the machine 102 is traveling. For example, the trolley system 122 may include electrified charging rails, wires, and/or other electrified components or charging mechanisms that extend along a portion of the worksite 100. Charging rails or wires of the trolley system 122 may, for instance, be positioned on, above, or alongside a portion of a road or other travel route at the worksite 100. The machine 102 may have a connector, such as rod, that may at least temporarily connect with the trolley system 122, and that may remain connected to elements of the trolley system 122 as the machine 102 travels above, under, or alongside a length of the trolley system 122.

The design of the trolley system 122 may also, or alternately, employ trolley poles, bow collectors, underbody collectors, and other forms of ‘live’ electricity transfer components. As an example, the trolley system 122 may include a ground-level power supply having one or more contact lines that may include conductive rails or tracks. The machine 102 may have an underbody collector interacts with the contract lines of the ground-level power supply. As another example, the trolley system 122 may include non-contact conductors, such as non-contact conductors that facilitate in-road or in-ground inductive charging. Accordingly, the trolley system 122 may embody any form of ‘live’ electricity supply and the machine 102 may have corresponding components that embody any form of ‘live’ electricity receipt, depending on specific applicational requirements, such that the machine 102 may receive energy from the trolley system 122 while traveling along the trolley system 122.

When the machine 102 travels while connected to the trolley system 122 during performance of an activity 106 of a production circuit 104, energy from the trolley system 122 may be transferred to the machine 102 via a connector or other energy transfer component, and may be used to power the machine 102 and/or charge the battery 112 of the machine 102 during performance of the activity 106. The energy use profile 120 associated with that activity 106 may indicate how much energy is expected to be received by the machine 102 from the trolley system 122 and/or is expected to be used to power the machine 102 and/or charge the battery 112 of the machine 102 during performance of the activity 106.

Accordingly, an activity 106 that involves the machine 102 traveling while connected to the trolley system 122 may allow the battery 112 to be charged, and/or operations of the machine 102 to be powered, by energy provided via the trolley system 122 as the machine 102 is traveling. For instance, in the example shown in FIG. 1, the trolley system 122 may be installed alongside a route through the worksite 100 that is associated with performance of activity 106B. The machine 102 may receive energy from the trolley system 122 while traveling during performance of activity 106B.

In some situations, the trolley system 122 may allow a machine 102 to perform an activity 106 that the machine 102 otherwise may not be able to perform. For instance, if a machine 102 is within a pit at the worksite 100 at a time when the charge state of the battery 112 is relatively low, the battery 112 may have insufficient energy to power travel of the machine 102 uphill out of the pit. However, by connecting to the trolley system 122 during uphill travel out of the pit, the machine 102 may receive energy that may be used to power the uphill travel and/or to increase the charge state of the battery 112 during uphill travel.

An activity 106 of a production circuit 104 may involve a machine 102 performing one or more other operations, such as productive work operations, in addition to receiving energy from the trolley system 122. For instance, in the example shown FIG. 1, activity 106B may involve loaded travel of the machine 102, such that machine 102 travels while carrying a load of material. However, activity 106B may also involve the machine 102 connecting to the trolley system during loaded travel, such that the machine 102 receives energy from the trolley system 122 while the machine 102 is also traveling and carrying material during performance of activity 106B.

In some examples, an energy use profile 120 associated with a particular activity 106 may indicate how energy usage by the machine 102 is predicted or expected to change throughout performance of the particular activity 106 by the machine 102. As an example, if an activity 106 involves first traveling through a flat or uphill portion of the worksite 100, and then traveling through a downhill portion of the worksite 100, the corresponding energy use profile 120 may indicate that the machine 102 will initially consume energy from the battery 112 while traveling through a flat or uphill portion of the worksite 100, but then charge the battery 112 with energy captured via regenerative braking while traveling through the downhill portion of the worksite 100.

Each activity 106 of a production circuit 104 may be associated with a corresponding energy use profile 120. For instance, in the example shown in FIG. 1, activity 106A may be associated with energy use profile 120A, activity 106B may be associated with energy use profile 120B, activity 106C may be associated with energy use profile 120C, activity 106D may be associated with energy use profile 120D, activity 106E may be associated with energy use profile 120E, and activity 106F may be associated with energy use profile 120F. The energy use profiles 120 associated with individual activities 106 of the production circuit 104 may accordingly indicate expected energy gain and/or expected energy loss by the machine 102 during performance of the individual activities 106. A combination of the energy use profiles 120 associated with all of the activities 106 of the production circuit 104 may similarly indicate expected net energy gain or net energy loss by the machine 102 throughput performance of the entire production circuit 104.

An energy use profile 120 associated with a particular activity 106 in a production circuit 104 may be different than energy use profiles 120 associated with similar activities 106 in the same production circuit 104 or in different production circuits. For instance, a production circuit 104 may include two instances of activities 106 that involve loaded travel of a machine 102. However, the energy use profiles 120 associated with the two loaded travel activities 106 may differ due to differences in terrain that will be traversed by the machine 102, differences how much material is expected to be carried by the machine 102, and/or other differences between the individual instances of the activities 106. As an example, if the first loaded travel activity 106 involves uphill travel and/or transportation of a relatively heavy load of material, while the second loaded travel activity 106 involves downhill travel and/or transportation of a relatively light load of material, the corresponding energy use profiles 120 may indicate that the machine 102 will use more energy during the first loaded travel activity 106 than the second loaded travel activity 106.

In some examples, the energy use profiles 120 associated with activities 106 of a production circuit 104 may also be based on attributes and/or capabilities of the machine 102 assigned to that production circuit 104. For instance, energy use profiles 120 associated with activities 106 of a production circuit 104 assigned to a particular machine 102, or a particular type of machine 102, may be based on information indicating how much energy that machine 102 is expected to use during certain operations, how much energy a regenerative braking system of the machine 102 is expected to capture during certain operations, how quickly the battery 112 of the machine 102 may be charged, and/or other information. Accordingly, if a first machine 102 and a second machine 102 may both perform a type of activity 106, but the first machine 102 is expected to consume more energy than the second machine 102 during that type of activity 106, corresponding energy use profiles 120 for the two machines may differ.

In some examples, energy use profiles 120 and/or other information associated with activities 106 that involve charging of the battery 112 may indicate nominal charge state values to which the battery 112 should be charged during the activities 106. For instance, although it may be possible to charge the battery 112 to a 100% charge state during a particular activity 106, the energy use profile 120 and/or other information associated with that particular activity 106 may indicate that the battery 112 should instead be charged to a charge state of 75%, or other lower charge state value, during the particular activity 106. This may, for example, prevent the machine 102 from waiting at a charge station to fully charge the battery 112 before moving to the next activity 106, when a lower charge state would be sufficient to allow the machine 102 to perform the next activity 106 and/or subsequent activities 106 in the production circuit 104, or if subsequent activities 106 in the production circuit 104 are expected to charge the battery 112 further via a trolley system 122 or regenerative braking.

Energy use profiles 120 and/or other information associated with activities 106 that involve charging of the battery 112 may also, or alternately, indicate target ranges of charge state values to which the battery 112 may be charged during the activities 106. For instance, a target charge state range associated with a particular activity 106 may indicate that charging of the battery 112 may cease after the charge state of the battery 112 reaches a lower limit of the target charge state range, or may continue up until the charge state of the battery 112 reaches an upper limit of the target charge state range.

As an example, if charging of the battery 112 during an activity 106 is causing the battery 112 to become relatively hot and exceed a threshold temperature, the ECM 114 may cause charging of the battery 112 to stop once the battery 112 reaches a charge state at a lower limit of a target charge state range associated with the activity 106. However, if the temperature of the battery 112 is not above the threshold temperature, the ECM 114 may allow charging of the battery 112 to continue during performance of the activity 106 up until the battery 112 reaches a charge state at a higher limit of the target charge state range associated with the activity 106.

As another example, if an activity 106 involves the machine 102 connecting to a trolley system 122 and receiving energy from the trolley system 122 while the machine 102 is connected to the trolley system 122, the activity 106 may be configured such that the battery 112 of the machine 102 is likely to have a charge state within a target charge state range associated with the activity 106. For instance, the activity 106 may be configured to cause the machine 102 to connect to the trolley system 122 for a particular period of time, during performance of the activity 106, that is likely to cause the charge state of the battery 112 to be at least at a lower limit of a target charge state range associated with the activity 106. However, the battery 112 may continue to charge for a longer time, and cause the charge state of the battery 112 to increase to up to a higher limit of the target charge state range, for instance if unexpected circumstances cause the machine 102 to travel for a longer period of time while connected to the trolley system 122 during performance of the activity 106.

Overall, the activities 106 of production circuits 104 may be associated with corresponding pre-determined energy use profiles 120. The dispatch controller 108 or another system may determine the energy use profiles 120 associated with activities 106.

As an example, the dispatch controller 108 may determine energy use profiles 120 for activities 106 based on historical information indicating how much energy was used and/or gained by one or more machines 102 in the past during performance of the activities 106 or similar activities 106. As another example, the dispatch controller 108 may use simulations, predictive modeling, machine learning techniques, and/or other processes to estimate or predict energy use profiles 120 for activities 106, for instance based on types of the activities 106, operations to be performed as part of the activities 106, worksite terrain information associated with the activities 106, machine attributes of machines 102 that may perform the activities 106, and/or other information.

In some examples, the dispatch controller 108 or another system may determine an overall amount of energy available to charge and/or power machines 102 at the worksite 100 during a workday or other period of time, for instance via charge stations and/or trolley systems 122 present at the worksite 100. The dispatch controller 108 or other system may allocate the available energy among different production circuits 104 and/or individual activities 106 of production circuits 104. The dispatch controller 108 or other system may accordingly determine energy use profiles 120 associated with activities 106 of production circuits 104 based at least in part on energy allocated to those activities 106 and/or production circuits 104.

The activities 106 of production circuits 104 may be associated with corresponding energy use profiles 120, as discussed above. The activities 106 of production circuits 104 may also, or alternately, be associated with corresponding entry criteria 124.

Entry criteria 124 of activities 106 may indicate conditions that, if satisfied, permit the machine 102 to initiate performance of the corresponding activities 106. As described further below, the ECM 114 of the machine 102, and/or the dispatch controller 108, may evaluate sensor data and/or other types of data to determine whether the machine 102 satisfies entry criteria 124 associated with individual activities 106 of a production circuit 104 and/or other production circuits 104.

Different activities 106 may have different entry criteria 124. For instance, in the example shown in FIG. 1, activity 106A may be associated with entry criteria 124A, activity 106B may be associated with entry criteria 124B, activity 106C may be associated with entry criteria 124C, activity 106D may be associated with entry criteria 124D, activity 106E may be associated with entry criteria 124E, and activity 106F may be associated with entry criteria 124F.

The entry criteria 124 for each activity may be predefined entry criteria 124 that the dispatch controller 108 or another system has determined should be satisfied in order for a machine 102 to initiate performance of the corresponding activities 106. For example, the dispatch controller 108 may have a user interface that allows a user to define a sequence of activities 106 of a production circuit 104. Energy use profiles 120 associated with the activities 106 of the production circuit 104 may also be determined by the dispatch controller 108 as discussed above. The dispatch controller 108 may also determine corresponding entry criteria 124 for each of the activities 106 of a production circuit 104, for instance based on user input, evaluation of corresponding energy use profiles 120, and/or other types of information. Information associated with the production circuit 104, including information such as the energy use profiles 120 and/or entry criteria 124 associated with each activity of the dispatch controller 108 may be stored by the dispatch controller 108 and/or provided to the machine 102 via production circuit assignment data 110.

For example, as discussed above, the dispatch controller 108 may transmit production circuit assignment data 110 to the ECM 114 of the machine 102. The production circuit assignment data 110 may assign the machine 102 to one or more production circuits 104, and may define the activities 106 and sequence of activities 106 associated with each of the assigned production circuits 104. The production circuit assignment data 110 may additionally indicate the entry criteria 124 for each of the activities 106 associated with one or more production circuits 104 assigned to the machine 102, and/or indicate the energy use profiles 120 for each of those activities 106. In some examples, the production circuit assignment data 110 may also indicate exit criteria associated with one or more of the assigned production circuits 104, as described further below.

Entry criteria 124 associated with a particular activity 106 in a production circuit 104 may include one or more energy-based conditions that are associated with the energy use profile 120 for that activity 106. For instance, entry criteria 124 associated with an activity 106 may indicate minimum battery charge state levels and/or maximum battery charge state levels associated with performance of the activity 106. Accordingly, the machine 102 may satisfy the entry criteria 124 associated with that activity 106, and may thus initiate performance of that activity 106, if the charge state of the battery 112 of the machine 102 is above the minimum battery charge state level, and/or is below the maximum battery charge state level, indicated by the entry criteria 124.

As an example, an energy use profile 120 of a particular activity 106 of a production circuit 104 may indicate that the charge state of the battery 112 of the machine 102 will drop by 10% during performance of the particular activity 106. Accordingly, the entry criteria 124 for the particular activity 106 may indicate that the machine 102 should not begin performance of that particular activity 106 unless the charge state of the battery 112 is at least 10% above a minimum operable level. The minimum operable level may be a charge state level that would allow the machine 102 to continue at least some operations without fully discharging the battery 112, for instance to allow the machine 102 to travel to a charge station to be recharged. The entry criteria 124 for the particular activity 106 may thus indicate a minimum battery charge state level that, if met by the machine 102, is sufficient to allow the machine 102 to complete the particular activity 106 without the charge state of the battery 112 dropping below the minimum operable level.

As another example, an energy use profile 120 of a particular activity 106 of a production circuit 104 may indicate that a trolley system 122 or regenerative braking is expected to increase the charge state of the battery 112 by 10% during performance of the particular activity 106. Accordingly, the entry criteria 124 for the particular activity 106 may indicate that the machine 102 should not begin performance of that particular activity 106 unless the charge state of the battery 112 is below 90%. In this example, the entry criteria 124 for the particular activity 106 may thus indicate a maximum battery charge state level of 90%, so that the battery 112 has sufficient remaining capacity to be charged by 10% during performance of the particular activity 106. The entry criteria 124 for the particular activity 106 may thus indicate a maximum battery charge state level that, if met by the machine 102, is sufficient to allow the machine 102 to complete the particular activity 106 without the machine 102 receiving or capturing energy that would be unable to be stored in the battery 112.

In some examples, energy-based conditions of entry criteria 124 for a particular activity 106 of a production circuit 104 may be based on the energy use profiles 120 of that particular activity 106 as well as energy use profiles 120 of one or more subsequent activities 106 in the production circuit 104. As an example, if the energy use profiles 120 of three consecutive activities 106 in a production circuit 104 indicate, in combination, that the charge state of the battery 112 will drop by 40% throughout performance of those three consecutive activities 106, the entry criteria 124 of the first of those three activities 106 may indicate that the machine 102 should not begin performance of that activity 106 unless the charge state of the battery 112 is at least 40% above a minimum operable level. The entry criteria 124 for the first of the three activities 106 may thus indicate a minimum battery charge state level that, if met by the machine 102, is sufficient to allow the machine 102 to complete the three consecutive activities 106 without the charge state of the battery 112 dropping below the minimum operable level.

If the machine 102 operates based on fuel consumption instead of being powered by a battery 112, energy-based conditions of entry criteria 124 for activities 106 of a production circuit 104 may also be based on minimum fuel levels, maximum fuel levels, and/or other fuel level metrics. For example, entry criteria 124 for a particular activity 106 of a production circuit 104 may indicate that the machine 102 may not begin performance of that particular activity unless the machine 102 has at least a threshold amount of fuel.

Although entry criteria 124 associated with activities 106 may define or be associated with energy-based conditions as discussed above, entry criteria 124 associated with activities 106 may also, or alternately, be based on other types of conditions. Such conditions associated with entry criteria 124 for activities 106 may be based on attributes and/or capabilities of the machine 102, attributes of material carried by the machine 102, and/or other types of information.

As an example, entry criteria 124 for a particular activity 106 of a production circuit 104 may define a particular type of material that should be carried by the machine 102 during performance of that activity 106. Accordingly, a machine 102 may begin performance of the activity 106 if the machine 102 is carrying the particular type of material defined in the entry criteria 124 for the activity 106.

If the machine 102 does not meet entry criteria 124 associated with a particular activity 106 of a production circuit 104, the machine 102 may be barred from initiating performance of that particular activity 106. However, if the machine 102 is barred from performing a particular activity 106 of a production circuit 104 due to non-compliance with the entry criteria 124 for that particular activity 106, the machine 102 may switch to performing an activity 106 of a different production circuit 104.

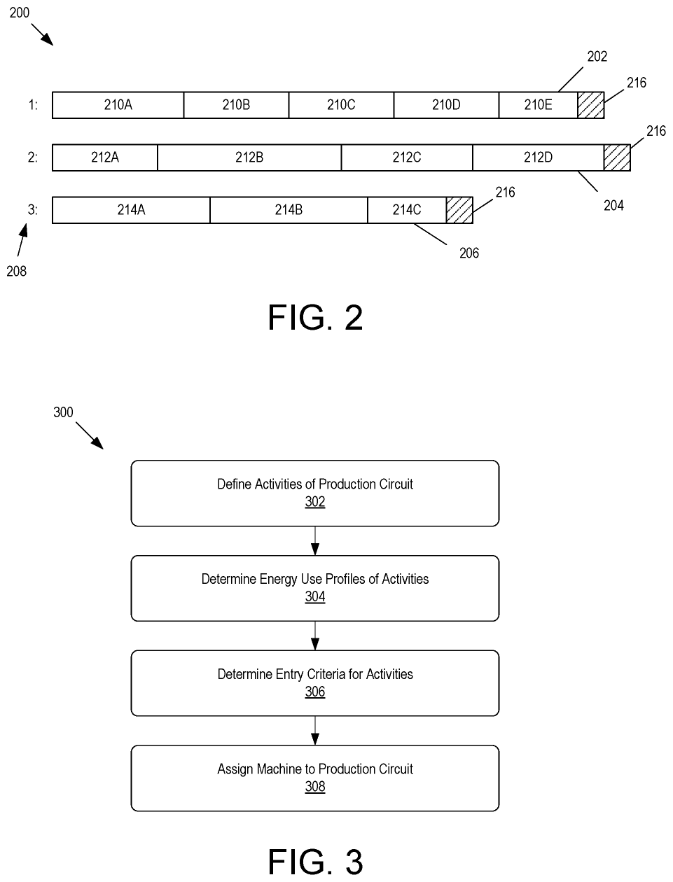

As an example, the production circuit assignment data 110 may assign the machine 102 to multiple production circuits 104, for instance via a ranked list as discussed further below with respect to FIG. 2. The machine 102 may attempt to perform an activity 106 of a first production circuit 104, such as the highest-ranked production circuit 104 on a ranked list. However, if the machine 102 does not meet the entry criteria 124 for that activity 106 of the first production circuit 104, the machine 102 may instead meet different entry criteria 124 for an activity of a different second production circuit 104, such as a lower-ranked production circuit 104 on the ranked list. In this situation, the machine 102 may switch from performing, or attempting to perform, activities 106 of the first production circuit 104, to instead performing activities 106 of the second production circuit 104 that have entry criteria 124 satisfied by the machine 102.

In some examples, a production circuit 104 may be associated with exit criteria in addition to, or instead of, entry criteria 124 associated with individual activities 106 of the production circuit 104. Such exit criteria may indicate conditions that, if satisfied, permit the machine 102 to complete performance of the production circuit 104 and switch to performing a different production circuit 104. Exit criteria associated with a production circuit may, for example, be associated with performance of the production circuit 104 a threshold number of times, a threshold amount of water or other material having been dispensed by the machine 102 during one or more executions of the production circuit 104, a particular pattern of water or other material having been dispensed by the machine 102 during one or more executions of the production circuit 104, a threshold amount of a type of material having been transported by the machine 102 during one or more executions of the production circuit 104, or any other conditions. If the machine 102 does not satisfy exit criteria of a production circuit 104 after the machine 102 completes performance of an iteration of the sequence of activities 106 of the production circuit 104, the machine 102 may continue performing that production circuit 104, for instance by repeating the sequence of activities 106 of the production circuit 104 one or more times, until the machine 102 satisfies the exit criteria of the production circuit 104.

Exit criteria of a production circuit 104 may, in some examples, be based on a goal or target associated with that production circuit 104. As an example, if the machine 102 is a water truck configured to dispense water, the production circuit 104 may have a sequence of activities 106 that involve the water truck dispensing water at a particular area of the worksite 100. Exit criteria for the production circuit 104 may be associated with a minimum saturation level for a surface of the particular area. Accordingly, after the machine 102 begins the production circuit 104, the machine 102 may repeat the sequence of activities 106 of the production circuit 104, and continue to dispense water at the particular area, until the saturation level of the surface of the particular area meets the minimum saturation level defined by the exit criteria for the production circuit 104. After the exit criteria of the production circuit 104 is met, the machine 102 may transition to performing activities 106 of a different production circuit 104, for instance if the machine 102 satisfies entry criteria 124 of an activity 106 of the different production circuit 104.

If the machine 102 has been performing a first production circuit 104 and exit criteria of the first production circuit 104 is satisfied upon completion of an instance of the first production circuit 104, the machine 102 may transition to performing a different second production circuit 104. For example, the second production circuit 104 may be a lower-priority production circuit 104 that is ranked lower than the first production circuit 104 on a ranked list of production circuits 104 assigned to the machine 102.

Although the machine 102 may be configured to transition from a first production circuit 104 to a different production circuit 104 once exit criteria associated with the first production circuit 104 has been met, the machine 102 may also transition from the first production circuit 104 to a different production circuit 104 earlier if the machine 102 does not satisfy entry criteria 124 of an activity of the first production circuit 104. For example, exit criteria of the first production circuit 104 may indicate that the first production circuit 104 is to be executed ten times overall, and that the machine 102 should transition to a different production circuit 104 after executing the first production circuit 104 ten times. However, during a fourth execution of the first production circuit 104, the machine 102 may not satisfy entry criteria 124 of one of the activities 106 of the first production circuit 104. Accordingly, the machine 102 may transition at least temporarily to performing activities 106 of a lower-priority second production circuit 104 for which the machine 102 does satisfy entry criteria 124. At a later time, the machine 102 may return to performing activities 106 of the first production circuit 104 if the machine 102 is able to satisfy entry criteria 124 of the activities 106 of the first production circuit 104.

In some examples, the ECM 114 of the machine 102 may use the wireless communication interfaces 118 to transmit sensor data, telemetry data, and/or other types of data to the dispatch controller 108. The dispatch controller 108 may also receive information associated with operations of the machine 102 at the worksite 100 from other sources, such as from a loading machine that has loaded material onto the machine 102 or from another type of machine or system that has interacted with the machine 102. The dispatch controller 108 may be configured to evaluate the data sent by the ECM 114 of the machine 102 and/or other data received from other sources, and determine whether the data indicates whether the machine 102 satisfies entry criteria 124 associated with the next activity 106 in a current production circuit 104 that the machine 102 is performing or attempting to perform.

The dispatch controller 108 may determine that the machine 102 meets the entry criteria 124 associated with the next activity 106 in the current production circuit 104. In some examples, the dispatch controller 108 may transmit instructions to the machine 102 that indicate that the machine 102 is permitted to perform the next activity 106 in the current production circuit 104, or that instructs the machine 102 to perform the next activity 106 in the current production circuit 104. In other examples, the dispatch controller 108 may avoid sending instructions that would prevent the machine 102 from performing the next activity 106 in the current production circuit 104, such that the machine 102 continues performing the current production circuit 104 without further instructions from the dispatch controller 108.

If the dispatch controller 108 instead determines that the machine 102 does not meet the entry criteria 124 associated with the next activity 106 in the current production circuit 104, the dispatch controller 108 may send instructions that stop the machine 102 from performing the next activity 106 in the current production circuit 104. The dispatch controller 108 may also determine whether the machine 102 satisfies entry criteria 124 of activities 106 in any other production circuits 104. If the machine 102 satisfies entry criteria 124 of an activity 106 in a different production circuit 104, the dispatch controller 108 may instruct the machine 102 to divert from the current production circuit 104 to the different production circuit 104. In some situations, the different production circuit 104 may be another production circuit 104 to which the machine 102 was previously assigned, such that the machine 102 may already have received production circuit assignment data 110 associated with the different production circuit 104. However, if the machine 102 was not previously assigned to the different production circuit 104, the dispatch controller 108 may transmit new production circuit assignment data 110 associated with the different production circuit 104 to the machine 102.

Accordingly, in these examples, the dispatch controller 108 may evaluate data reported by the machine 102 substantially in real-time to determine whether the machine 102 satisfies entry criteria 124 of each activity 106 of a current production circuit 104. The dispatch controller 108 may similarly evaluate data, substantially in real-time, to determine whether the machine 102 satisfies exit criteria of a production circuit 104. The dispatch controller 108 may accordingly remotely manage operations of the machine 102 substantially in real-time, for instance to permit the machine 102 to continue performing activities 106 in the current production circuit 104 if the machine 102 satisfies corresponding entry criteria 124 and exit criteria of the current production circuit 104 has not yet been met, or to divert the machine 102 to perform activities 106 of a different production circuit 104 if the machine 102 does not satisfy entry criteria 124 of an activity 106 in the current production circuit 104 or exit criteria of the current production circuit 104 has been met.

However, in other examples, the ECM 114 of the machine 102 may locally determine whether the machine 102 satisfies entry criteria 124 of each activity 106 of a current production circuit 104 and may continue performing the current production circuit 104, or does not satisfy entry criteria 124 of an activity 106 in the current production circuit 104 and should switch to performing activities 106 of a different production circuit 104. The ECM 114 of the machine 102 may similarly evaluate data, locally in real-time, to determine whether the machine 102 satisfies exit criteria of a production circuit 104. In these examples, the ECM 114 may have previously received, from the dispatch controller 108, production circuit assignment data 110 that defines activities 106 of one or more production circuits 104. Accordingly, the ECM 114 may use the production circuit assignment data 110, along with sensor data captured by sensors 116 of the machine 102 or provided to the machine 102 by other elements different from the dispatch controller 108, to determine whether the exit criteria of a production circuit 104 has been met and/or whether the machine 102 satisfies entry criteria 124 of activities 106 of production circuits 104 independently, without real-time management of the machine 102 by the dispatch controller 108.

For instance, if network availability at the worksite 100 is unreliable or spotty, the ECM 114 may be configured to operate based on previously-received production circuit assignment data 110 to locally determine whether the machine 102 should continue performing activities 106 of a current production circuit 104 or should switch to performing activities 106 of a different production circuit 104. The ECM 114 may, in some examples, send sensor data, material tracking data, activity performance data, and/or other data to the dispatch controller 108, indicating which activities and/or production circuits 104 the machine 102 has performed, when network connectivity is available or becomes available after a period of unavailability. However, the ECM 114 may be configured to use previously-received production circuit assignment data 110 to locally and independently determine which production circuits 104 and/or activities 106 the machine 102 should perform at different times and/or in different situations, without real-time remote management of the machine 102 by the dispatch controller 108.

In other examples, the dispatch controller 108 may be configured to remotely manage operations of the machine 102 substantially in real-time, as discussed above, during periods of time in which a data connection exists between the dispatch controller 108 and the machine 102. However, in these examples, if the data connection is lost or becomes unavailable, the ECM 114 of the machine 102 may fall back to using previously-received production circuit assignment data 110 to locally and independently determine which production circuits 104 and/or activities 106 the machine 102 should perform at different times and/or in different situations.

Overall, the machine 102 may perform the activities 106 of a particular production circuit 104 in sequence if the machine 102 meets the entry criteria 124 of each successive activity 106 in the particular production circuit 104. The machine 102 may then repeat the same production circuit 104 one or more additional times by performing the activities 106 of the production circuit 104 again, for example if the machine 102 continues to meet the entry criteria 124 of each activity 106 in the particular production circuit 104 and if the exit criteria of the particular production circuit 104 has not yet been met.

However, in some situations, the machine 102 may perform the activities 106 of a first production circuit 104, and then change to performing activities 106 of a different second production circuit 104 after completing the first production circuit 104. As an example, if the machine 102 completes all of the activities 106 of the first production circuit 104, but does not meet the entry criteria 124 for beginning a subsequent activity 106 in order to repeat the first production circuit 104 again, the machine 102 may switch to performing activities 106 of a second production circuit 104 instead of performing the first production circuit 104 again. As another example, if the machine 102 completes all of the activities 106 of the first production circuit 104, and exit criteria associated with the first production circuit 104 has been met, the machine 102 may switch to performing activities 106 of a second production circuit 104 instead of performing the first production circuit 104 again.

Similarly, in some situations, the machine 102 may perform one or more activities 106 of a first production circuit 104, but change to performing activities 106 of a different production circuit 104 without having completed all of the activities 106 of the first production circuit 104. For example, if the machine 102 has been performing activities 106 of the first production circuit 104, but does not meet entry criteria 124 of an activity 106 that is midway through the first production circuit 104, the machine may switch to performing activities 106 of a second production circuit 104 instead of continuing to perform activities 106 of the first production circuit 104.

In situations in which the machine 102 switches from one production circuit 104 to another production circuit 104, the switch between the production circuits 104 may be based on a ranked list of production circuits 104 assigned to the machine 102 by the dispatch controller 108. For instance, the production circuit assignment data 110 sent by the dispatch controller 108 to the ECM 114 of the machine 102 may include a ranked list of production circuits 104. The dispatch controller 108 and/or the ECM 114 may prioritize keeping the machine 102 on the highest-ranked production circuit 104 on the ranked list for which the machine 102 meets corresponding entry criteria 124. In some examples, the dispatch controller 108 and/or the ECM 114 may prioritize keeping the machine 102 on the highest-ranked production circuit 104 until exit criteria associated with the highest-ranked production circuit 104 is met. However, when the machine 102 does not meet entry criteria 124 for an activity 106 of a higher-priority production circuit 104, and/or when exit criteria of the higher-priority production circuit 104 has been met, the dispatch controller 108 or the ECM 114 may switch the machine 102 to a lower-priority production circuit 104 for which the machine 102 meets corresponding entry criteria 124. An example of a ranked list of production circuits 104, and switching between production circuits 104 based on a ranked list, is discussed further below with respect to FIG. 2.

FIG. 2 shows an exemplary illustration of a ranked set 200 of production circuits 104 that may be assigned to a machine 102. As described above with respect to FIG. 1, the dispatch controller 108 may assign multiple production circuits 104 to a particular machine 102, and may transmit production circuit assignment data 110 to the machine 102 that indicates a ranked set 200 of the multiple production circuits 104 assigned to the machine 102. The ranked set 200 shown in FIG. 2 may be an example of rankings of production circuits 104 that are associated to an individual machine 102.

The ranked set 200 shown in the example of FIG. 2 includes a first production circuit 202, a second production circuit 204, and a third production circuit 206. The first production circuit 202, the second production circuit 204, and the third production circuit 206 may be instances of production circuits 104, and may include different sequences of activities 106.

For example, the first production circuit 202 may include a first sequence that includes five activities 106, including activity 210A, activity 210B, activity 210C, activity 210D, and activity 210E (collectively referred to as activities 210 of the first production circuit 202). The second production circuit 204 may include a second sequence of four activities 106, including activity 212A, activity 212B, activity 212C, and activity 212D (collectively referred to as activities 212 of the second production circuit 204). The third production circuit 206 may include a third sequence of three activities 106, including activity 214A, activity 214B, and activity 214C (collectively referred to as activities 214 of the third production circuit 206).

Although FIG. 2 shows sequences of activities 106 associated with the first production circuit 202, the second production circuit 204, and the third production circuit 206, in some examples a machine 102 may begin performance of any of those production circuits 104 at any of their activities 106. As an example, a machine 102 may begin performing the first production circuit 202 at activity 210C, and then continue the sequence of activities 210 associated with the first production circuit 202 by performing activity 210D, activity 210E, activity 210A, and activity 210B. After completing an instance of all of the activities 210 of the first production circuit 202, the first production circuit 202 may be considered complete, and in some situations the machine 102 may repeat the first production circuit 202. For example, if the machine 102 completes a sequence of activity 210C, activity 210D, activity 210E, activity 210A, and activity 210B, the machine 102 may be considered to have completed one instance of the first production circuit 202, and may begin a second instance of the first production circuit 202 by performing activity 210C again.

As discussed above, a production circuit 104 may, in some examples, be associated with exit criteria defining conditions in which the machine 102 is to complete performance of the production circuit 104 and transition to performing a different production circuit 104 instead of repeating the same production circuit 104. For example, as shown in FIG. 2, exit criteria 216 may be associated with the first production circuit 202, the second production circuit 204, and/or the third production circuit 206.

In some examples, exit criteria 216 may be associated with overall instances of the production circuits 104, instead of designated activities 106 within the production circuits 104. For example, if a machine 102 begins performance of the first production circuit 202 at activity 210C, the exit criteria 216 associated with the first production circuit 202 may be evaluated after the machine 102 has completed activity 210B and has finished one instance of all of the activities 210 of the first production circuit 202. However, if the machine 102 begins performance of the first production circuit 202 at activity 210A, the exit criteria 216 associated with the first production circuit 202 may be evaluated after the machine 102 has completed activity 210E and has finished one instance of all of the activities 210 of the first production circuit 202.

The ranked set 200 of production circuits 104 may indicate a priority level 208 associated with each of the multiple production circuits 104. The ranked set 200 may be ordered based on the priority levels 208 of the production circuits 104. For instance, in the example shown in FIG. 2, the first production circuit 202 may have the highest priority level 208 in the ranked set 200, the second production circuit 204 may have a lower priority level 208 in the ranked set 200 than the first production circuit 202, and the third production circuit 206 may have the lowest priority level 208 in the ranked set 200.

The priority levels 208 of the production circuits 104 on the ranked set 200 may accordingly indicate a ranked priority-based hierarchy of the production circuits 104. The ECM 114 and/or the dispatch controller 108 may be configured to prioritize causing the machine 102 to perform activities 106 of the highest-priority production circuit 104 for which the machine 102 meets corresponding entry criteria 124.

As an example, in the example of FIG. 2, the ranked set 200 may cause the machine 102 to prioritize performing the activities 210 of the first-ranked first production circuit 202 as long as the machine 102 satisfies corresponding entry criteria 124 of the activities 210 of the first production circuit 202. However, if the machine 102 does not satisfy entry criteria 124 of an activity 210 in the first production circuit 202, the machine 102 may fall back to performing one or more activities 212 of the second-ranked second production circuit 204 if the machine 102 satisfies entry criteria 124 of the activities 212 of the second production circuit 204, because the second production circuit 204 has the next-highest priority level 208 after the first production circuit 202. If the machine 102 does not satisfy entry criteria 124 associated with activities 106 of the first production circuit 202 or the second production circuit 204, the machine 102 may fall back to performing one or more activities 212 of the lowest-ranked third production circuit 206 if the machine 102 satisfies entry criteria 124 of the activities 214 of the third production circuit 206.

In some situations, the ECM 114 and/or the dispatch controller 108 may also be configured to prioritize causing the machine 102 to perform activities 210 of the first-ranked first production circuit 202 until exit criteria 216 associated with the first production circuit 202 has been met. Once the exit criteria 216 associated with the first production circuit 202 has been met, the ECM 114 and/or the dispatch controller 108 may prioritize causing the machine 102 to perform activities 220 of the second-ranked second production circuit 204. However, if the machine 102 has been performing activities 210 of the first-ranked first production circuit 202 and exit criteria 216 associated with the first production circuit 202 has not yet been met, but the machine 102 does not satisfy entry criteria 124 of an activity 210 in the first production circuit 202, the machine 102 may fall back to performing activities 106 of the lower-ranked second production circuit 204 or third production circuit 206.

If the machine 102 falls back to performing activities 106 of a lower-priority production circuit 104 in the ranked set 200, but later satisfies entry criteria 124 of an activity 106 in a higher-priority production circuit 104 in the ranked set 200, the machine 102 may switch from the lower-priority production circuit 104 to the higher-priority production circuit 104. In some examples, the machine 102 may switch from the lower-priority production circuit 104 to the higher-priority production circuit 104 if the exit criteria 216 associated with the higher-priority production circuit 104 has not yet been met. As an example, if the machine 102 did not meet entry criteria 124 for an activity 210 of the highest-priority first production circuit 202 and fell back to performing activities 106 of the second production circuit 204 or the third production circuit 206, but later does meet entry criteria 124 for an activity 210 of the highest-priority first production circuit 202 and exit criteria 216 of the highest-priority first production circuit 202 has not yet been met, the machine 102 may switch from the second production circuit 204 or the third production circuit 206 to the highest-priority first production circuit 202.

The ranked set 200 may be designed or generated such that the production circuits 104 are complementary and/or allow the machine 102 to continue to perform productive work operations at the worksite 100 as often as possible. For instance, the machine 102 may meet entry criteria 124 of activities 106 in different production circuits 104 in the ranked set 200 at different times and/or in different situations, and may accordingly switch between the different production circuits 104.

As a first example, activity 210A of the highest-priority first production circuit 202 may have entry criteria 124 indicating that the machine 102 may perform activity 210A if the machine 102 is carrying a load of ore. Activity 212A of the lower-ranked second production circuit 204 may have entry criteria 124 indicating that the machine 102 may perform activity 212A if the machine 102 is carrying a load of waste material. In this example, a loading machine at the worksite 100 may load material into the machine 102 from a material source that is 70% ore and 30% waste material, such that it may be unpredictable whether the loading machine will load ore or waste material into the machine 102 at a particular time. Accordingly, although the first production circuit 202 involving transport of ore may have the highest priority level 208, the second production circuit 204 involving transport of waste material may also be provided in the ranked set 200 so that the machine 102 may follow the second production circuit 204 in situations in which the loading machine loads the machine 102 with waste material instead of ore.

For instance, if the machine 102 is loaded with waste material in this example, the machine 102 does not satisfy the entry criteria 124 of activity 210A of the highest-priority first production circuit 202. However, the machine 102 may instead satisfy the entry criteria 124 of activity 212A of the second production circuit 204. The machine 102 may accordingly follow one or more activities 212 of the second production circuit 204, for instance to transport the waste material to a particular destination at the worksite 100 and then be loaded with another load of material. If the next load of material is a load of ore, instead of a load of material, the machine 102 may then satisfy the entry criteria 124 of activity 210A of the highest-priority first production circuit 202, and the machine 102 may accordingly switch back to performing the highest-priority first production circuit 202.

As another example, the lowest-ranked third production circuit 206 may be a default production circuit 104 that includes activities 106 with no entry criteria 124, or with entry criteria 124 that the machine 102 may be likely to satisfy even if the machine 102 does not satisfy entry criteria 124 of any of the higher-ranked production circuits 104. The lowest-ranked third production circuit 206 may also lack exit criteria 216 in some examples, such that the machine 102 may always be able to fall back to performing the lowest-ranked third production circuit 206 without regard for whether exit criteria 216 of the lowest-ranked third production circuit 206 has been met.

For example, one or more of the activities 214 of the third production circuit 206 may be associated with dedicated charging operations, for instance at a charge station or a trolley system. Activities 106 of the higher-ranked first production circuit 202 and second production circuit 204 may have entry criteria 124 that define minimum charge state levels for the battery 112 of the machine 102. Accordingly, if the charge state of the battery 112 of the machine 102 is relatively low, such that the machine 102 does not satisfy entry criteria 124 of activities 106 in the higher-ranked first production circuit 202 or second production circuit 204, the machine 102 may fall back to the lowest-ranked third production circuit 206 in order to charge the battery 112 of the machine 102. Once the battery 112 of the machine 102 has been charged to a charge state level that satisfies the entry criteria 124 of an activity 106 in a higher-ranked production circuit 104, the machine 102 may switch from the third production circuit 206 to the higher-ranked production circuit 104.

In this example, the first production circuit 202 and/or the second production circuit 204 may include activities 106 with energy use profiles 120 indicating that the battery 112 of the machine 102 will be charged during performance of those activities 106. However, the lowest-priority third production circuit 206 may be included in the ranked set 200 as a backup plan such that the machine 102 may fall back to the charging-focused third production circuit 206 if the charge state of the battery 112 becomes too low to perform activities in the first production circuit 202 or the second production circuit 204. Alternatively, the first production circuit 202 and the second production circuit 204 may include activities 106 that do not involve charging of the battery 112 of the machine 102, such that the machine 102 may be likely to perform multiple instances of the first production circuit 202 and/or the second production circuit 204, fall back to the third production circuit 206 to charge the battery 112 when the charge state of the battery 112 becomes too low to continue performing the first production circuit 202 and/or the second production circuit 204, and then return to performing the first production circuit 202 and/or the second production circuit 204 after the battery 112 is charged via the third production circuit 206.

The ranked set 200 may be used by either the ECM 114 of the machine 102 or the dispatch controller 108 to determine which production circuit 104 the machine 102 should be performing. For example, the ECM 114 may be configured to operate based on a ranked set 200, indicated by production circuit assignment data 110 previously received from the 108, to locally determine whether the machine 102 should continue performing activities 106 of a current production circuit 104 or should switch to performing activities 106 of a lower-priority production circuit 104 or a higher-priority production circuit 104. As another example, if the dispatch controller 108 has a real-time data connection with the ECM 114 of the machine 102, the dispatch controller 108 may be configured to operate based on a ranked set 200 of production circuits 104 assigned to the machine 102 to remotely determine whether the machine 102 should continue performing activities 106 of a current production circuit 104 or should switch to performing activities 106 of a lower-priority production circuit 104 or a higher-priority production circuit 104, and send corresponding instructions to the ECM 114 of the machine 102 via the real-time data connection.

Although the example ranked set 200 shown in FIG. 2 includes three production circuits 104, in other examples a machine 102 may be assigned a ranked set 200 of production circuits 104 that includes fewer production circuits 104, or more production circuits 104, than are shown in FIG. 2. Additionally, individual production circuits 104 within a ranked set 200 may include different numbers of activities 106, different types of activities 106, and/or different sequences of activities 106 than are discussed herein with respect to FIG. 2. The dispatch controller 108 or another system may define activities 106 of production circuits 104, and assign a ranked set 200 of production circuits 104 to a machine 102 as discussed further below with respect to FIG. 3.

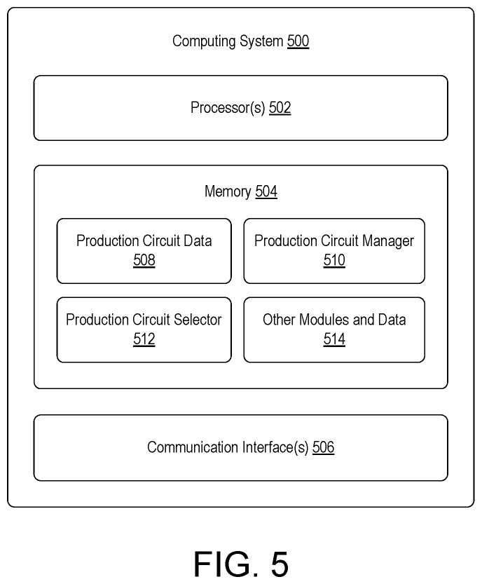

FIG. 3 is a flowchart 300 illustrating an exemplary process for generating production circuits 104 and assigning production circuits 104 to machines 102. The operations shown in FIG. 3 may be performed by one or more computing systems, such as a computing system that executes the dispatch controller 108. FIG. 5, discussed further below, describes an example system architecture for such a computing system.

At block 302, the computing system may define activities 106 of a production circuit 104. For example, the computing system may determine which types of activities 106 are associated with the production circuit 104, such as which types of work operations are associated with the activities, which types of machines 102 may perform the activities 106, locations of the activities 106 at the worksite 100, and/or other types of information about the activities 106 of the production circuit 104. The computing system may also determine a sequence of the activities 106, such that the production circuit 104 is associated with a particular sequence of activities 106.

In some examples, the computing system may define activities 106 of a production circuit 104 based on a production plan associated with the worksite 100, based on user input, and/or based on any other information. For instance, a production plan associated with the worksite 100 may indicate locations of elements at the worksite 100, such as locations of material sources, material destinations, locations of charge stations, locations of trolley systems, and/or locations of other elements. The production plan may also indicate a map of the worksite 100, indicate terrain information associated with the worksite 100, indicate production goals associated with the worksite 100, indicate types of machines 102 available to work at the worksite 100, indicate how many machines 102 are available to work at the worksite 100, and/or any other information. Accordingly, at block 302, the computing system may use such a production plan, corresponding user input, and/or other types of information to generate and/or edit a production circuit 104 that a machine 102 may follow to perform productive work at the worksite 100.

At block 304, the computing system may determine energy use profiles 120 associated with the activities 106 of the production circuit 104. The energy use profiles 120 associated with the activities 106 may indicate how much energy is expected to be expended and/or gained by an assigned machine 102 while the machine 102 performs the activities 106.

In some examples, the computing system may determine energy use profiles 120 for activities 106 based on historical information indicating how much energy was used and/or gained by one or more machines 102 in the past during performance of the activities 106 or similar activities 106. In other examples, the computing system may use simulations, predictive modeling, machine learning techniques, and/or other processes to estimate or predict energy use profiles 120 for activities 106, for instance based on information about the activities 106 determined at block 302.

In some examples, the computing system may also, or alternately, determine an overall amount of energy available to charge and/or power machines 102 at the worksite 100 during a period of time. The computing system may allocate the available energy among different production circuits 104 and/or individual activities 106 of production circuits 104, and determine energy use profiles 120 associated with activities 106 of the production circuit 104 at block 304 based at least in part on energy allocated to the activities 106 of the production circuit 104.

At block 306, the computing system may determine the entry criteria 124 associated with the activities 106 of the production circuit 104. The entry criteria 124 of activities 106 may indicate conditions that, if satisfied, permit the machine 102 to initiate performance of the corresponding activities 106.

In some examples, the conditions associated with entry criteria 124 of a particular activity 106 may include one or more energy-based conditions, such as minimum battery charge state levels and/or maximum battery charge state levels associated with performance of the activity 106. The computing system may determine such energy-based conditions for entry criteria 124 associated with an activity 106 at block 306 based on energy use profiles 120 associated with that particular activity 106 and/or subsequent activities 106 in the production circuit 104.

In other examples, the conditions associated with entry criteria 124 of a particular activity 106 may also, or alternately, include one or more other types of conditions based on attributes and/or capabilities of the machine 102, attributes of material carried by the machine 102, and/or other types of information. Such conditions may be determined based on the type of the activity 106, types of subsequent activities in the production circuit 104, based on user input, and/or other information.

In some examples, the computing system may also determine exit criteria associated with the production circuit 104. For example, user input or other data may indicate how many times the production circuit 104 should be performed, and/or other conditions upon which the machine 102 should complete performance of the production circuit 104 and transition to performing a different production circuit 104.

At block 308, the computing system may assign a machine 102 to the production circuit 104. For example, the computing system may transmit production circuit assignment data 110, associated with the production circuit 104, to the ECM 114 of the machine 102. The production circuit assignment data 110 may identify the types of activities 106 associated with the production circuit 104, the sequence of activities 106 associated with the production circuit 104, the energy use profiles 120 and/or entry criteria 124 associated with the activities 106 of the production circuit 104, exit criteria associated with the production circuit 104, and/or other information associated with the production circuit 104.

In some examples, the computing system may repeat block 302 through block 306 for different production circuits 104, such as different production circuits 104 to which one or more machines 102 could be assigned at the worksite 100. The computing system may also assign the same production circuit 104 and/or different production circuits 104 to different machines 102 at block 308. Additionally, the computing system may assign multiple production circuits 104 to the same machine 102 at block 308, for instance by determining a ranked set 200 of production circuits 104 and indicating the ranked set 200 in the production circuit assignment data 110 sent to the machine 102.

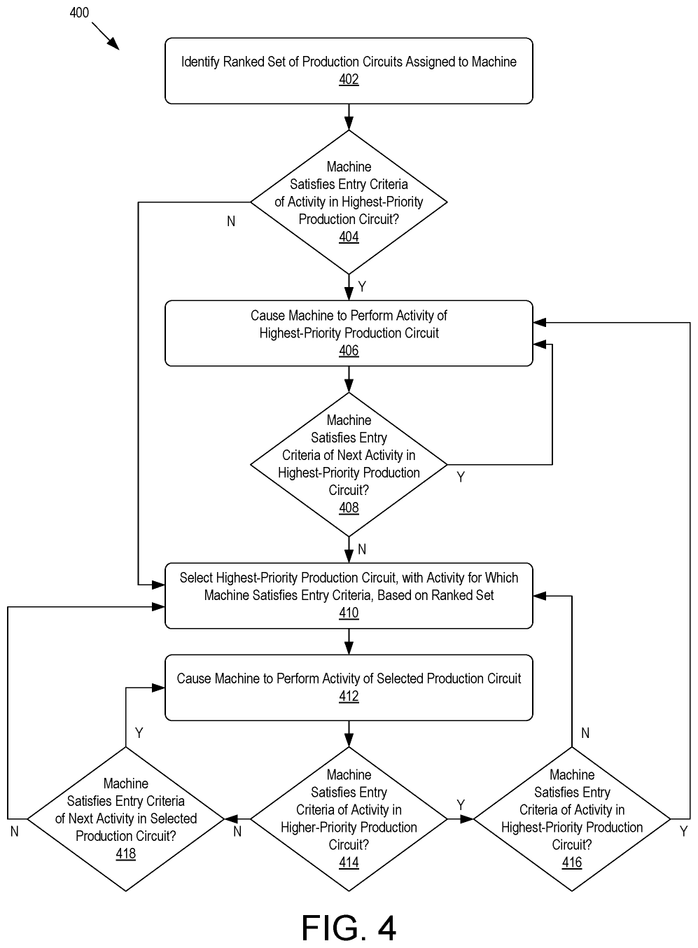

After the machine 102 is assigned to one or more production circuits 104, the ECM 114 of the machine 102, or the dispatch controller 108, may determine which production circuit 104 to perform and/or determine whether the machine 102 is permitted to perform activities 106 of production circuits 104 based on corresponding entry criteria 124 and/or based on exit criteria of the production circuits 104. An example of operations to determine which production circuit 104 and/or activity 106 a machine 102 is to be perform at the worksite 100 is discussed further below with respect to FIG. 4.

FIG. 4 is a flowchart 400 illustrating an exemplary process for switching between production circuits 104 assigned to a machine 102. The operations shown in FIG. 4 may be performed by one or more computing systems, such as the ECM 114 of the machine 102 or a computing system that executes the dispatch controller 108. FIG. 5, discussed further below, describes an example system architecture for such a computing system. In some examples, the ECM 114 of the machine 102 may locally perform some or all the operations of FIG. 4 on-board the machine 102. In other examples, the dispatch controller 108 may perform some or all the operations of FIG. 4 remotely, and may provide corresponding instructions to the ECM 114 of the machine 102 via the wireless communication interfaces 118.

At block 402, the computing system may identify a ranked set 200 of production circuits 104 assigned to the machine 102. For example, if the computing system is the ECM 114 of the machine 102, the ECM 114 may have received production circuit assignment data 110 from the dispatch controller 108 that indicates the ranked set 200 of production circuits 104 assigned to the machine 102. If the computing system is instead the dispatch controller 108, the dispatch controller 108 may identify the ranked set 200 of production circuits 104 assigned to the machine 102 based on data stored at, or available to, the dispatch controller 108.

As discussed above, each of the production circuits 104 may be associated with a particular sequence of activities 106, and each of the activities 106 may be associated with corresponding entry criteria 124. Individual activities 106 may also be associated with corresponding energy use profiles 120. Accordingly, in some examples, entry criteria 124 associated with activities 106 may be associated with energy use profiles 120 of those activities 106 and/or subsequent activities 106 in the production circuits 104.

The ranked set 200 may indicate priority levels 208 of corresponding production circuits 104 that have been assigned to the machine 102. The priority levels 208 may indicate priority rankings of the assigned production circuits 104, and thereby indicate which of the production circuits 104 in the ranked set 200 is the highest-priority production circuit 104 assigned to the machine 102, as well as relative priorities of one or more lower-priority production circuits 104 in the ranked set 200. The priority levels 208 of the production circuits 104 in the ranked set 200 may accordingly be configured to cause the machine 102 to perform activities 106 of the highest-priority production circuit 104 if the machine 102 satisfies corresponding entry criteria 124, or fall back to performing activities of a lower-priority production circuit 104 if the machine 102 does not satisfy entry criteria 124 of an activity 106 in the highest-priority production circuit 104.

At block 404, the computing system may determine whether the machine 102 satisfies entry criteria 124 of an activity 106 in the highest-priority production circuit 104 in the ranked set 200. The computing system may evaluate sensor data captured by one or more sensors 116 of the machine 102, and/or other types of data indicative of the current state of the machine 102, to determine whether the machine 102 satisfies the entry criteria 124 associated with the activity 106. As an example, if the entry criteria 124 of the activity 106 indicates a minimum battery charge state level and a maximum battery charge state level, the computing system may use sensor data indicating a current charge state level of the battery 112 to determine whether the current charge state level of the battery 112 meets or exceeds the minimum battery charge state level and does not exceed the maximum battery charge state level.

As another example, if the entry criteria 124 of the activity 106 indicates a particular type and/or amount of material, the computing system may use sensor data, material tracking data, and/or other types of data to determine whether the machine 102 is currently carrying the particular type and/or amount of material defined by the entry criteria 124 of the activity 106. For instance, sensor data captured by sensors 116 of the machine 102, and/or that is provided by a loading machine that loaded material onto the machine 102, may indicate the type and/or amount of material being carried by the machine 102. Accordingly, the computing system may use such sensor data to determine whether the machine 102 satisfies the entry criteria 124 of the activity 106.

If the machine 102 satisfies the entry criteria 124 of the activity 106 of the highest-priority production circuit 104 (Block 404—Yes), the computing system may cause the machine 102 to perform the activity 106 of the highest-priority production circuit 104 at block 406. For example, if the computing system is the ECM 114, the ECM 114 may cause the machine 102 to perform the activity 106 of the highest-priority production circuit 104 autonomously or semi-autonomously, or may cause instructions associated with the activity 106 to be displayed to an operator of the machine 102 via a user interface so that the operator may cause the machine 102 to perform the activity 106. If the computing system is the dispatch controller 108, the dispatch controller 108 may transmit instructions to the wireless communication interfaces 118 of the machine 102, such that the ECM 114 may cause the instructions to be presented an operator of the machine 102 or use the instructions to cause the machine 102 to perform the activity 106 autonomously or semi-autonomously.

After the machine 102 performs the activity 106 of the highest-priority production circuit 104 at block 406, the computing system may determine whether the machine 102 satisfies the entry criteria 124 of the next activity 106 in the highest-priority production circuit 104 at block 408. The highest-priority production circuit 104 may be a sequence of activities 106, such that the machine 102 may continue with the next activity 106 in the sequence if the machine 102 satisfies the entry criteria 124 of the next activity 106. Similar to block 404, at block 408 the computing system may evaluate sensor data and/or other types of data indicative of the current state of the machine 102 to determine whether the machine 102 satisfies the entry criteria 124 associated with the next activity 106 in the highest-priority production circuit 104.

If the computing system determines that the machine 102 does satisfy the entry criteria 124 associated with the next activity 106 in the highest-priority production circuit 104 (Block 408—Yes), the computing system may return to block 406 to cause the machine 102 to perform the next activity 106 of the highest-priority production circuit 104. The computing system may loop through block 406 and block 408 to cause the machine 102 to continue performing activities 106 of the highest-priority production circuit 104, in some instances by repeating an activity 106 to restart the highest-priority production circuit 104 again after completing a full instance of the highest-priority production circuit 104, as long as the machine 102 continues to satisfy the entry criteria 124 of each subsequent activity 106 in the highest-priority production circuit 104.

However, if the computing system determines that the machine 102 does not satisfy the entry criteria 124 associated with an activity 106 in the highest-priority production circuit 104 (Block 404—No), or if the machine 102 has performed one or more activities 106 in the highest-priority production circuit 104 and the computing system then determines that the machine 102 does not satisfy the next activity 106 in the highest-priority production circuit 104 (Block 408—No), the computing system may select a different lower-priority production circuit 104 for the machine 102 at block 410. For example, at block 410 the computing system may select the next highest-priority production circuit 104 in the ranked set 200 that has an activity 106 with entry criteria 124 that the machine 102 does satisfy.

As an example, if the ranked set 200 includes five production circuits 104, the machine 102 may not satisfy entry criteria 124 associated with an activity 106 in the production circuit 104 that has the highest priority, and may not satisfy entry criteria 124 associated with an activity 106 in the production circuit 104 that has the second-highest priority. However, the machine 102 may satisfy entry criteria 124 associated with an activity 106 in the production circuit 104 that has the third-highest priority, and the computing system may accordingly select the production circuit 104 with the third-highest priority in the ranked set 200 at block 410.

At block 412, the computing system may cause the machine 102 to perform the activity 106 of the selected production circuit 104 for which the machine 102 satisfies the corresponding entry criteria 124. For example, if the computing system is the ECM 114, the ECM 114 may cause the machine 102 to perform the activity 106 of the selected production circuit 104 autonomously or semi-autonomously, or may cause instructions associated with the activity 106 to be displayed to an operator of the machine 102 via a user interface so that the operator may cause the machine 102 to perform the activity 106. If the computing system is the dispatch controller 108, the dispatch controller 108 may transmit instructions to the wireless communication interfaces 118 of the machine 102, such that the ECM 114 may cause the instructions to be presented an operator of the machine 102 or use the instructions to cause the machine 102 to perform the activity 106 autonomously or semi-autonomously.

After the machine 102 performs the activity 106 of the currently-selected production circuit 104 at block 412, the computing system may determine at block 414 whether the machine 102 satisfies the entry criteria 124 of an activity 106 in a different production circuit 104 in the ranked set 200 that has a higher priority than the currently-selected production circuit 104. For example, if the currently-selected production circuit 104 has the third-highest priority in the ranked set 200, the computing system may determine at block 414 whether the machine 102 satisfies entry criteria 124 of an activity 106 in either of the two higher-priority production circuits 104 in the ranked set 200.

If the computing system determines that the machine 102 does satisfy entry criteria 124 of an activity 106 in a higher-priority production circuit 104 in the ranked set 200 (Block 414—Yes), the computing system may determine at block 416 whether the machine 102 satisfies the entry criteria 124 of an activity 106 in the highest-priority production circuit 104 in the ranked set 200. If the machine 102 satisfies entry criteria 124 of an activity 106 in production circuit 104 that has a higher priority than the currently-selected production circuit 104 (Block 414—Yes), but that production circuit 104 is not the highest-ranked production circuit 104 in the ranked set 200 (Block 416—No), the computing system may return to block 410 to select the highest-priority production circuit 104 in the ranked set 200 that has an activity 106 with entry criteria 124 that the machine 102 does satisfy. If the machine 102 satisfies entry criteria 124 of an activity 106 in production circuit 104 that has a higher priority than the currently-selected production circuit 104 (Block 414—Yes), and that production circuit 104 is the highest-ranked production circuit 104 in the ranked set 200 (Block 416—Yes), the computing system may cause the machine 102 to perform the activity 106 of the highest-priority production circuit 104 at block 406.

If the machine 102 performed an activity 106 of a currently-selected production circuit 104 that is not the highest-ranked production circuit 104 at block 412, and the computing system determines that the machine 102 does not satisfy entry criteria 124 of an activity 106 in any higher-priority production circuit 104 in the ranked set 200 (Block 414—No), the computing system may determine at block 418 whether the machine 102 satisfies the entry criteria 124 of the next activity 106 in the currently-selected production circuit 104 at block 418. The currently-selected production circuit 104 may be a sequence of activities 106, such that the machine 102 may continue with the next activity 106 in the sequence if the machine 102 satisfies the entry criteria 124 of the next activity 106. Similar to block 404 and block 408, at block 418 the computing system may evaluate sensor data and/or other types of data indicative of the current state of the machine 102 to determine whether the machine 102 satisfies the entry criteria 124 associated with the next activity 106 in the currently-selected production circuit 104.

If the computing system determines that the machine 102 does satisfy the entry criteria 124 associated with the next activity 106 in the currently-selected production circuit 104 (Block 418—Yes), the computing system may return to block 412 to cause the machine 102 to perform the next activity 106 of the currently-selected production circuit 104. The computing system may loop through block 412, block 414, and block 418 to cause the machine 102 to continue performing activities 106 of the currently-selected production circuit 104, in some instances by re-starting the currently-selected production circuit 104 after completing a full instance of the currently-selected production circuit 104 production circuit 104, as long as the machine 102 continues to satisfy the entry criteria 124 of each subsequent activity 106 in the currently-selected production circuit 104 and is not found at block 414 to satisfy entry criteria 124 of an activity 106 in a higher-priority production circuit 104.

If the computing system instead determines that the machine 102 does not satisfy the entry criteria 124 associated with the next activity 106 in the currently-selected production circuit 104 (Block 418—No), the computing system may return to block 410 to select a different lower-priority production circuit 104 that has an activity 106 with entry criteria 124 that the machine 102 satisfies. For example, if the currently-selected production circuit 104 has the third-highest priority level 208 in the ranked set 200, and the machine 102 satisfies entry criteria 124 of a production circuit 104 with the fourth-highest priority level 208 in the ranked set 200, the computing system may select the production circuit 104 with the fourth-highest priority level 208 at block 410. The computing system may then cause the machine 102 to perform the activity 106 of the newly-selected production circuit 104 at block 412.

In some examples, the computing system may perform the operations shown in FIG. 4 additionally based on exit criteria 216 of the production circuits 104 in the ranked set 200. One or more of the production circuits 104 in the ranked set 200 may, in some examples, be associated with corresponding exit criteria 216 indicating conditions in which the machine 102 should complete performance of the production circuits 104 and transition to performing a different production circuit. Accordingly, in these examples, the computing system may cause the machine 102 to perform an activity 106 of a particular production circuit 104 if the machine 102 satisfies the entry criteria 124 of that activity 106 and if the exit criteria 216 of the particular production circuit 104 has not yet been met. If the exit criteria 216 of the particular production circuit 104 has been met, the computing system may cause the machine 102 to perform an activity 106 of a different production circuit 104 even if the machine 102 otherwise satisfies entry criteria 124 of an activity 106 in the particular production circuit 104.

For example, if the computing system determines at block 404 that the machine 102 does satisfy entry criteria 124 of an activity 106 in the highest-priority production circuit 104, the computing system may determine that exit criteria 216 of the highest-priority production circuit 104 has already been met. In this situation, the computing system may select the next highest-priority production circuit at block 410 for which exit criteria 216 has not yet been met, instead of causing the machine 102 to perform an activity 106 of the highest-priority production circuit 104 at block 406.

As described above, in some examples a machine 102 may fall back to performing one or more activities 106 of a lower-priority production circuit 104 in the ranked set 200, but move to a higher-priority production circuit 104 as soon as the machine 102 satisfies entry criteria 124 of an activity 106 of the higher-priority production circuit 104. However, in other examples, if a machine 102 begins performing a lower-priority production circuit 104 in the ranked set 200, the machine 102 may continue performing the lower-priority production circuit 104 even if the machine 102 satisfies entry criteria 124 of an activity 106 of the higher-priority production circuit 104.

As a first example, if the machine 102 begins performing a production circuit 104 that has the third-highest priority level 208 in the ranked set 200, the machine 102 may continue performing activities 106 of that third-ranked production circuit 104 until exit criteria 216 of the third-ranked production circuit 104 is met. Accordingly, in this example, the machine 102 may continue performing activities 106 of the third-ranked production circuit 104 until its exit criteria 216 is met even if the machine 102 satisfies entry criteria 124 of an activity 106 in the highest-priority production circuit 104 and/or an activity 106 in the second-ranked production circuit 104. Accordingly, in some examples, the computing system may skip block 414 and/or block 416 until exit criteria 216 of the currently-selected production circuit 104 is met.

As a second example, the machine 102 may begin performing a production circuit 104 that does not have the highest priority level 208 in the ranked set 200. During performance of that lower-ranked production circuit 104, the machine 102 may satisfy entry criteria 124 of an activity 106 in a higher-ranked production circuit 104. However, the machine 102 may continue performing the lower-ranked production circuit 104, instead of switching to the higher-ranked production circuit 104, if a cost measure associated with switching to the higher-ranked production circuit 104 exceeds a cost threshold. The cost measure and cost threshold may be based on a time it would take for the machine 102 to switch between the production circuits 104, an amount of fuel or energy it would take for the machine 102 to switch between the production circuits 104, a metric of productive work that would be lost in association with the machine 102 switching between the production circuits 104, and/or other any other metrics. In this example, although the machine 102 may satisfy entry criteria 124 of an activity 106 of a higher-ranked production circuit 104, the machine 102 may nevertheless continue performing activities 106 of the current lower-ranked production circuit 104 instead of switching to the higher-ranked production circuit 104 because a time cost, energy cost, productive work cost, and/or other cost measure associated with switching to the higher-ranked production circuit 104 exceeds a corresponding cost threshold. Accordingly, in some examples, the computing system may skip block 414 and/or block 416, and therefore not consider whether to switch to a higher-priority production circuit 104, if a cost measure associated with the potential switch exceeds a cost threshold.

Overall, the computing system may prioritize causing the machine 102 to perform activities 106 of the highest-priority production circuit 104 in the ranked set 200 if the machine 102 satisfies corresponding entry criteria 124 and/or if exit criteria 216 of the highest-priority production circuit 104 has not yet been met, for instance at block 404 through block 408 and/or via switching the machine 102 to the highest-priority production circuit 104 from a lower-priority production circuit 104 at block 416. If the machine 102 does not satisfy entry criteria 124 of the highest-priority production circuit 104 and/or if exit criteria 216 of the highest-priority production circuit 104 has been met, the computing system may cause the machine 102 to perform activities 106 of the next highest-priority production circuit 104 in the ranked set 200 for which the machine 102 does satisfy entry criteria 124. For instance, the computing system may keep the machine 102 on a currently-selected lower-priority production circuit if the machine 102 continues to satisfy entry criteria 124 of activities 106 of the currently-selected production circuit 104, may switch the machine 102 to an even lower-priority production circuit 104 if the machine 102 does not satisfy entry criteria 124 of an activity 106 of the currently-selected production circuit, or may switch the machine 102 to a higher-priority production circuit 104 if the machine 102 satisfies entry criteria 124 of an activity 106 of the higher-priority production circuit 104.

In some examples or situations, the dispatch controller 108 may perform the operations of FIG. 4. For instance, the dispatch controller 108 may perform the operations of FIG. 4 if a real-time data connection exists between the dispatch controller 108 and the wireless communication interfaces 118 of the machine 102, such that the dispatch controller 108 may receive sensor data and/or other data from the ECM 114 of the machine 102 and/or send instructions to the ECM 114 of the machine 102 via the data connection. Accordingly, in these examples, the dispatch controller 108 may, in real-time or near real-time, evaluate whether received data indicates that the machine 102 satisfies entry criteria 124 of an activity 106, and return instructions to the ECM 114 of the machine 102 that cause the machine 102 to perform the next activity 106 in a current production circuit 104 or to switch to a higher-priority production circuit 104 or a lower-priority production circuit 104.

However, in other examples or situations, the ECM 114 of the machine 102 may locally perform the operations of FIG. 4 on-board the machine 102. For instance, the ECM 114 may be configured to locally perform the operations of FIG. 4 based on production circuit assignment data 110 received from the dispatch controller 108, if the production circuit assignment data 110 indicates the ranked set 200 of production circuits 104 assigned to the machine 102. The ECM 114 may accordingly locally use sensor data and/or other data to determine whether the data indicates that the machine 102 satisfies entry criteria 124 of an activity 106, and accordingly cause the machine 102 to perform the next activity 106 in a current production circuit 104 or to switch to a higher-priority production circuit 104 or a lower-priority production circuit 104. Accordingly, after the ECM 114 has received the production circuit assignment data 110 from the dispatch controller 108, the ECM 114 may use the operations of FIG. 4 to locally cause the machine 102 to perform activities 106 of one or more production circuits 104 without the dispatch controller 108 providing real-time instructions indicating which activities 106 and/or which production circuits 104 to perform. In some examples, the ECM 114 may periodically or occasionally transmit reports to the dispatch controller 108 indicating which activities 106, and/or which production circuits 104, the machine 102 is and/or has been performing.

In some examples, the dispatch controller 108 may perform the operations of FIG. 4 and provide corresponding real-time instructions to the ECM 114 of the machine 102 if a real-time data connection between the dispatch controller 108 and the ECM 114 is available. However, if a real-time network connection is unavailable at the worksite 100, or is unreachable by the wireless communication interfaces 118 of the machine 102, the ECM 114 of the machine 102 may perform the operations of FIG. 4 while the dispatch controller 108 is unable to communicate with the ECM 114 via the real-time network connection.

For instance, during a first period of time, the wireless communication interfaces 118 of the machine 102 may have a wireless data connection to a network hotspot set up within the worksite 100. The ECM 114 of the machine 102 may use the wireless communication interfaces 118 to transmit sensor data, indicative of the state of the machine 102, to the dispatch controller 108. The dispatch controller 108 may use the received sensor data to determine whether the machine 102 satisfies entry criteria 124 of activities 106 of production circuits 104 as discussed with respect to FIG. 4, and return corresponding instructions to the ECM 114 via the wireless data connection. However, during a second period of time, the network hotspot may experience an error and go offline, or the machine 102 may travel to a location at the worksite 100 that is relatively far away from the network hotspot such that the wireless communication interfaces 118 of the machine 102 are unable to establish or maintain a wireless data connection that would allow real-time communications between the ECM 114 and the dispatch controller 108. Accordingly, during the second period of time, the ECM 114 may locally use sensor data to determine whether the machine 102 satisfies entry criteria 124 of activities 106 of production circuits 104, and cause corresponding operations of the machine 102 as discussed with respect to FIG. 4, without using a real-time connection with the dispatch controller 108.

FIG. 5 is a schematic illustration depicting an exemplary architecture of a computing system 500 that executes one or more elements described in the present disclosure. The computing system 500 may include one or more processors 502, memory 504, and communication interfaces 506.

In some examples, the computing system 500 may be the ECM 114 of the machine 102 or other computing system that is on-board the machine 102. Accordingly, the computing system 500 may perform local operations on-board the machine 102 that are associated with production circuits 104, such as determining which production circuit 104 in a ranked set 200 and/or defined within production circuit assignment data 110 the machine 102 should perform, and/or to determine whether the machine 102 meets entry criteria 124 of an activity 106 of a production circuit 104.

In other examples, the computing system 500 may be, or execute, the dispatch controller 108 or other external systems that are separate and/or remote from the machine 102. In some of these examples, the computing system 500 may be a local server or other local computing device that is physically present at or near the worksite 100. In other examples, the computing system 500 may be a remote server or other remote computing system that is located at a remote location relative to the worksite 100. For instance, the computing system 500 may be executed via a remote server, a cloud computing environment, or other computing system that is not present at the worksite 100.

The processor(s) 502 of the computing system 500 may operate to perform a variety of functions as set forth herein. The processor(s) 502 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 502 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 502 may also access content and computer-executable instructions stored in the memory 504, and execute such computer-executable instructions.

The memory 504 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 502 to perform the operations described herein.

For example, the memory 504 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 502 and/or communication interface(s) 506 during execution thereof by the computing system 500. For example, the processor(s) 502 may possess local memory, which also may store program modules, program data, and/or one or more operating systems.

The memory 504 may store data and/or computer-executable instructions associated with production circuits 104. As an example, the memory 504 may store production circuit data 508 that defines activities 106 of production circuits 104, sequences of activities 106 of production circuits 104, energy use profiles 120 associated with activities 106 of production circuits 104, entry criteria 124 associated with activities 106 of production circuits 104, ranked sets 200 of production circuits 104, and/or other types of information. For example, if the computing system 500 is the dispatch controller 108, the production circuit data 508 may include predefined information about production circuits 104 that may be assigned to machines 102 and/or that have been assigned to machines 102. If the computing system 500 is the ECM 114 of the machine 102, the production circuit data 508 may include production circuit assignment data 110 received from the dispatch controller 108 and/or other information associated with production circuits 104 to which the machine 102 has been assigned.

As another example, if the computing system 500 is the dispatch controller 108, the memory 504 may store data and/or computer-executable instructions associated with a production circuit manager 510. The production circuit manager 510 may be configured to generate production circuits 104 based on user input, information about the worksite 100, and/or other information, for instance to design production circuits 104, determine energy use profiles 120 and/or entry criteria 124 associated with activities 106 of the production circuits 104, and/or to perform other operations. The production circuit manager 510 may accordingly generate and/or modify production circuit data 508 associated with corresponding production circuits 104. The production circuit manager 510 may also assign one or more production circuits to one or more machines 102, automatically and/or based on user input. For instance, the production circuit manager 510 may cause the dispatch controller 108 to transmit production circuit assignment data 110 that defines one or more production circuits 104 that are assigned to a particular machine 102. As described above, the production circuit assignment data 110 may identify the types and/or sequence of activities 106 associated with the assigned production circuits 104. The production circuit assignment data 110 may also indicate energy use profiles 120 and/or entry criteria 124 associated with activities 106 of the assigned production circuits 104. In some examples, if a machine 102 is assigned to multiple production circuits 104, the production circuit assignment data 110 may indicate a ranked set 200 of the assigned production circuits 104 that indicates corresponding priority levels 208 of the assigned production circuits 104.

As another example, the memory 504 may store data and/or computer-executable instructions associated with a production circuit selector 512. The production circuit selector 512 may be configured to determine, based on sensor data and/or other information, whether the machine 102 satisfies entry criteria 124 associated with activities 106 of assigned production circuits 104. The production circuit selector 512 may also be configured to determine, based on evaluating whether the machines 102 satisfies such entry criteria 124 whether the machine 102 should perform activities 106 of a particular production circuit 104 or should switch to a different production circuit 104 assigned to the machine 102.

The memory 504 may also store other modules and data 514 that may be utilized by the computing system 500 to perform or enable performing any action taken by the computing system 500. For example, the other modules and data 514 may include a platform, operating system, and/or applications, as well as data utilized by the platform, operating system, and/or applications.

The communication interfaces 506 may include transceivers, modems, interfaces, antennas, and/or other components that may transmit and/or receive data over networks or other data connections. In some examples, the communication interfaces 506 may be the wireless communication interfaces 118, or other wired communication interfaces and/or wireless communication interfaces that the computing system 500 may use to send and/or receive data. As an example, if the computing system 500 is the ECM 114 of the machine 102, the ECM 114 may use the communication interfaces 506 to receive production circuit assignment data 110 from the dispatch controller 108, receive other instructions or data from the dispatch controller 108, transmit sensor data, location data, material tracking data, and/or other types of data to the dispatch controller 108, and/or to otherwise send and/or receive data. As another example, if the computing system 500 is the dispatch controller 108, the dispatch controller 108 may use the communication interfaces 506 to transmit production circuit assignment data 110 to the ECM 114 of the machine 102, send other instructions or data to the ECM 114, receive sensor data, location data, material tracking data, and/or other types of data from the ECM 114, and/or to otherwise send and/or receive data.

### INDUSTRIAL APPLICABILITY

As described herein, production circuits 104 associated with operations of machines 102 at a worksite 100 may include sequences of activities 106 associated with corresponding entry criteria 124. The entry criteria 124 associated with an individual activity 106 may indicate conditions that, if satisfied, permit a machine 102 to initiate performance of that activity 106. In some examples, a production circuit 104 may also be associated with exit criteria indicating when a machine 102 should complete performance of the production circuit 104 and should transition to performing a different production circuit.

Machines 102 assigned to the production circuits 104 may perform the activities 106 of the production circuits 104 if the machines 102 satisfy the entry criteria 124 corresponding to the activities 106. If a machine 102 does not satisfy entry criteria 124 of an activity 106 in a first assigned production circuit 104, but does satisfy entry criteria 124 of an activity 106 in a second assigned production circuit 104, the machine 102 may perform the activity 106 of the second assigned production circuit 104 instead of performing the activity 106 in the first assigned production circuit 104. In some examples, a machine 102 may also continue to perform a particular production circuit 104 until exit criteria of the particular production circuit 104 is satisfied and/or until the machine 102 does not satisfy entry criteria 124 of an activity of the particular production circuit 104, at which point the machine 102 may transition to performing a different assigned production circuit 104.

Machines 102 may be assigned ranked sets of production circuits 104, such that performance of activities 106 in higher-ranked production circuits 104 may be prioritized. However, machines 102 may fall back to performing activities 106 in lower-ranked production circuits 104 if the machines 102 do not satisfy entry criteria 124 of the activities 106 in the higher-ranked production circuits 104, and/or if exit criteria of the higher-ranked production circuits 104 become satisfied.

Accordingly, after a machine 102 has been assigned to one or more production circuits 104 at the worksite 100, for instance to a ranked set of production circuits 104, a computing system may determine which of the assigned production circuits 104 the machine 102 should follow depending on the current situation, without the machine 102 being assigned to individual activities in real-time. Operations at the worksite 100 may thus be more efficient, lead to more productive work, involve lower costs, and/or have other benefits relative to previous systems.

For example, some previous systems may have a central worksite controller that tracks each machine at a worksite, and that assigns individual new activities to each machine substantially in real-time. However, setting up and maintaining network infrastructure at the worksite in order to facilitate real-time assignment of individual activities to machines may be expensive and time-consuming, and thus increase the total costs involved in owning and/or operating at the worksite. Moreover, such systems that rely on real-time assignments of individual activities to machines may experience problems and lead to non-productive downtime if a real-time data connection becomes unavailable at the worksite, such that the central worksite controller is unable to assign new activities to the machines and the machines may lack instructions on which activities to perform next.

However, by assigning machines 102 to one or more larger production circuits 104 that may each include any number and/or type of activity 106, machines 102 may perform activities 106 of the already-assigned production circuits without a central controller constantly evaluating machine progress data and making real-time determinations of which new activities to assign the machine to perform. Accordingly, if a real-time data connection with the dispatch controller 108 is unavailable, the ECM 114 of the machine 102 may use previously-received production circuit assignment data 110 to determine which production circuits 104 have been assigned to the machine 102, use sensor data and/or other data to determine whether the machine 102 satisfies entry criteria 124 of activities 106 in the assigned production circuits 104, determine whether exit criteria of assigned production circuits 104 have been met, and switch between assigned production circuits 104 based on evaluation of entry criteria 124 associated with corresponding activities 106 and/or exit criteria associated with corresponding production circuits 104.

The machine 102 may therefore perform, and continue performing, productive work at the worksite 100 based on previously-assigned production circuits 104 even if a real-time data connection with the dispatch controller 108 is unavailable. Operations at the worksite 100 may accordingly be more resilient to network failures. Operations at the worksite 100 may also proceed with fewer network infrastructure resources, such as fewer network hotspots, thereby lowing costs associated with setting up and maintaining network infrastructure at the worksite 100.

In other situations, a real-time data connection between the dispatch controller 108 and the machine 102 may be available at the worksite 100. In some examples, the dispatch controller 108 may receive sensor data and/or other data associated with operations of the machine 102 via the real-time data connection. The dispatch controller 108 may compare the received data against entry criteria 124 of activities 106 in one or more production circuits 104 already assigned to the machine 102, and/or use the received data to evaluate exit criteria of the assigned production circuits 104, to determine whether the machine 102 should continue to perform a currently-selected production circuit 104 or should switch to performing a higher-priority or a lower-priority production circuit 104. However, because the production circuits 104 may have already been assigned to the machine 102, a processing load, a network bandwidth usage level, and/or other computing resource usage by the dispatch controller 108 may be reduced relative to the dispatch controller 108 assigning the machine 102 to new individual activities in real-time.

For instance, if the machine 102 is performing a sequence of activities 106 of an assigned production circuit 104, the dispatch controller 108 may determine that the machine 102 satisfies entry criteria 124 of each subsequent activity 106 in the already-assigned production circuit 104. The dispatch controller 108 may accordingly send minimal instructions to the ECM 114 of the machine 102 to indicate that the machine 102 has permission to perform each subsequent activity 106 in the already-assigned production circuit 104, or may avoid sending any instructions such that the ECM 114 continues to cause the machine 102 to perform each subsequent activity 106 in the already-assigned production circuit 104 without interruption. In these situations, the amount of data sent to the machine 102 may be lower than if the dispatch controller 108 were to send the machine 102 assignments of new activities 106, and/or definitions or instructions associated with such newly-assigned activities. Similarly, if the dispatch controller 108 determines that the machine 102 does not satisfy entry criteria 124 of a particular activity of an assigned production circuit 104 or that the exit criteria of that production circuit 104 has been met, the dispatch controller 108 may send relatively small instructions that redirect the machine 102 to perform a different production circuit 104 that has already been assigned to the machine 102, rather than sending new assignment data that defines alternate newly-assigned activities in real-time.

Overall, by assigning machines 102 to production circuits 104 that include defined sequences of activities 106, rather than assigning machines 102 to individual activities in real-time, the load on the dispatch controller 108 may be reduced, operations at the worksite 100 may be more efficient and/or less expensive, and/or the amount of productive work performed at the worksite 100 may be increased. As an example, after assigning machines 102 to production circuits 104, the dispatch controller 108 may avoid assigning individual activities 106 to machines 102 in real-time. As another example, if a real-time data connection between the dispatch controller 108 and a machine 102 is unavailable, the machine 102 may perform productive activities 106 of one or more previously-assigned production circuits 104 rather than waiting and not performing any productive work until a new activity assignment is received once a data connection becomes available.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A computer-implemented method, comprising:
identifying, by a computing system comprising a processor, a production circuit assigned to a machine at a worksite, wherein:
the production circuit comprises a sequence of activities associated with operations at the worksite, and
individual activities, of the sequence of activities, are associated with corresponding entry criteria defining conditions for performing the individual activities;
determining, by the computing system, and based on sensor data indicative of a state of the machine, that the machine satisfies the entry criteria associated with an activity of the production circuit; and
causing, by the computing system, and based on determining that the machine satisfies the entry criteria associated with the activity, the machine to perform the activity.

2. The computer-implemented method of claim 1, wherein the production circuit is a first production circuit assigned to the machine, the activity is a first activity of the first production circuit, and the entry criteria associated with the first activity is first entry criteria, the method further comprising:
determining, by the computing system, and based on the sensor data, that the machine does not satisfy second entry criteria associated with a second activity of the first production circuit;
identifying, by the computing system, and based on the sensor data, a third activity of a second production circuit assigned to the machine;
determining, by the computing system, and based on the sensor data, that the machine satisfies third entry criteria associated with the third activity of the second production circuit; and
causing, by the computing system, and based on determining that the machine satisfies the third entry criteria associated with the third activity of the second production circuit, the machine to perform the third activity of the second production circuit.

3. The computer-implemented method of claim 2, wherein the second production circuit is ranked lower than the first production circuit in a ranked set of production circuits assigned to the machine.

4. The computer-implemented method of claim 1, wherein the sequence of activities of the production circuit includes a charging activity configured to charge a battery of the machine.

5. The computer-implemented method of claim 4, wherein the charging activity comprises the machine:
connecting to a trolley system at the worksite; and
receiving energy from the trolley system while the machine performs at least one of a travel operation or a work operation while receiving the energy.

6. The computer-implemented method of claim 4, wherein an energy use profile associated with the activity indicates at least one of a nominal charge state value or a range of charge state values to which the battery of the machine is to be charged during performance of the activity.

7. The computer-implemented method of claim 1, wherein the entry criteria associated with the activity indicates at least one of:
a minimum battery charge state level for a battery of the machine, or
a maximum battery charge state level for the battery of the machine.

8. The computer-implemented method of claim 7, wherein:
the at least one of the minimum battery charge state level or the maximum battery charge state level are based at least in part on an energy use profile associated with the activity, and
the energy use profile indicates an amount of energy predicted to be used by, or received or captured by, the machine during performance of the activity.

9. The computer-implemented method of claim 1, wherein the entry criteria associated with the activity indicates at least one or a type or amount of material carried by the machine.

10. The computer-implemented method of claim 1, further comprising:
identifying, by the computing system, exit criteria associated with the production circuit; and
determining, by the computing system, that the exit criteria associated with the production circuit has not been met,
wherein the computing system causes the machine to perform the activity of the production circuit based on:
determining that the machine satisfies the entry criteria associated with the activity, and
determining, by the computing system, that the exit criteria associated with the production circuit has not been met.

11. The computer-implemented method of claim 1, wherein:
the computing system is an electronic control module (ECM) of the machine,
the ECM receives production circuit assignment data, assigning the machine to the production circuit, from a dispatch controller via a data connection, and
the ECM causes the machine to perform the activity via at least one of:
autonomous operations, or
by presenting instructions associated with the activity to an operator via a user interface.

12. The computer-implemented method of claim 1, wherein:
the computing system is a dispatch controller separate from the machine,
the dispatch controller receives the sensor data from the machine via a data connection, and
the dispatch controller causes the machine to perform the activity by sending corresponding instructions to the machine via the data connection.

13. A machine comprising:
one or more sensors configured to determine sensor data indicative of a state of the machine; and
a computing system, comprising a processor and memory having stored thereon computer-executable instructions that, when executed by the processor, cause the processor to:
identify a production circuit assigned to the machine, wherein:
the production circuit comprises a sequence of activities associated with operations at a worksite, and
individual activities, of the sequence of activities, are associated with corresponding entry criteria defining conditions for performing the individual activities;
determine, based on the sensor data, that the machine satisfies the entry criteria associated with an activity of the production circuit; and
causing, based on determining that the machine satisfies the entry criteria associated with the activity, the machine to perform the activity.

14. The machine of claim 13, wherein:
a ranked set of different production circuits is assigned to the machine,
the production circuit is a first production circuit that has a first priority level in the ranked set,
the activity is a first activity of the first production circuit,
the entry criteria associated with the first activity is first entry criteria,
the ranked set comprises a second production circuit that:
comprises a second sequence of activities, and
has a second priority level that is lower than the first priority level, and the computer-executable instructions further cause the processor to:
determine, based on the sensor data, that the machine does not satisfy second entry criteria associated with a second activity of the first production circuit;
determine, based on the sensor data, that the machine satisfies third entry criteria associated with a third activity of the second production circuit; and
causing, based on determining that the machine satisfies the third entry criteria associated with the third activity of the second production circuit, the machine to perform the third activity of the second production circuit.

15. The machine of claim 14, wherein the computer-executable instructions further cause the processor to:
determine, based on the sensor data, and following performance of the third activity of the second production circuit, that the machine satisfies fourth entry criteria associated with a fourth activity of the first production circuit; and
causing, based on determining that the machine satisfies the fourth entry criteria associated with the fourth activity of the first production circuit, the machine to:
return from the second production circuit to the first production circuit; and
perform the fourth activity of the first production circuit.

16. The machine of claim 13, further comprising:
a battery configured to store energy operable to power operations of the machine,
wherein the entry criteria associated with the activity indicates at least one of:
a minimum battery charge state level for the battery, or
a maximum battery charge state level for the battery.

17. The machine of claim 16, wherein:
the at least one of the minimum battery charge state level or the maximum battery charge state level are based at least in part on an energy use profile associated with the activity, and
the energy use profile indicates at least one of:
a first amount of the energy predicted to be consumed from the battery during performance of the activity by the machine, or
a second amount of the energy predicted to be received from an external source, or captured by a regenerative braking system of the machine, during performance of the activity by the machine.

18. A computing system, comprising:
a processor; and
a memory having stored thereon computer-executable instructions that, when executed by the processor, cause the processor to:
identify a production circuit assigned to a machine at a worksite, wherein:
the production circuit comprises a sequence of activities associated with operations at the worksite, and
individual activities, of the sequence of activities, are associated with corresponding entry criteria defining conditions for performing the individual activities;
determine, based on sensor data indicative of a state of the machine, that the machine satisfies the entry criteria associated with an activity of the production circuit; and
cause, based on determining that the machine satisfies the entry criteria associated with the activity, the machine to perform the activity.

19. The computing system of claim 18, wherein:
the memory stores data associated with a ranked set of different production circuits assigned to the machine, the different production circuits being associated with respective priority levels, and
the production circuit has a highest priority level, of the respective priority levels, among two or more of the different production circuits that comprise activities for which the machine satisfies corresponding entry criteria.

20. The computing system of claim 18, wherein:
the entry criteria associated with the activity indicates at least one of:
a minimum battery charge state level for a battery of the machine, or
a maximum battery charge state level for the battery of the machine,
the at least one of the minimum battery charge state level or the maximum battery charge state level are based at least in part on an energy use profile associated with the activity, and
the energy use profile indicates at least one of:
a first amount of the energy predicted to be consumed from the battery of the machine during performance of the activity by the machine, or
a second amount of the energy predicted to be received from an external source, or captured by a regenerative braking system of the machine, during performance of the activity by the machine.
